(19) United States
(12) Patent Application Publication
(10) Pub. No.: US 2026/0052432 A1
(43) Pub. Date: Feb. 19, 2026

(54) METHODS AND ARRANGEMENTS TO COMMUNICATE UE CONTEXT INFORMATION

(71) Applicant: Intel Corporation, Santa Clara, CA (US)

(72) Inventors: Jaemin HAN, Portland, OR (US); NICHOLAS WHINNETT, Bath (GB); Dawei YING, Portland, OR (US); Leifeng RUAN, Beijing (CN); Jan SCHRECK, Scotts Valley, CA (US)

(73) Assignee: Intel Corporation, Santa Clara, CA (US)

(21) Appl. No.: 19/100,807

(22) PCT Filed: Sep. 5, 2023
(86) PCT No.: PCT/US2023/032006

§ 371 Date: Feb. 3, 2025

Related U.S. Application Data
(60) Provisional application No. 63/403,826, filed on Sep. 5, 2022.

(51) Int. Cl. H04W 36/00

(52) U.S. Cl. CPC H04W 36/0058; H04W 36/0033

(57) ABSTRACT

Logic may determine user equipment (UE) context information associated with a UE, the UE context information comprising new information related to establishment of a new connection with the UE or related to an update of the UE context information for an existing connection with the UE. Logic may identify an event trigger associated with new information. And logic may respond to a query from the near-RT RIC for UE context information associated with the UE, wherein the UE supports a non-grid of beams mode for beamforming.

### CROSS REFERENCE TO RELATED APPLICATIONS

This application claims priority under 35 USC § 119 from U.S. Provisional Application No. 63/403,826, entitled “SUPPORT FOR UE CONTEXT INFORMATION RETRIEVAL OVER E2 INTERFACE”, filed on Sep. 5, 2022, the subject matter of which is incorporated herein by reference.

### TECHNICAL FIELD

Embodiments herein relate to wireless communications, and more particularly, to communication of UE context information via a network interface.

### BACKGROUND

O-RAN has been striving to embrace artificial intelligence (AI) and machine learning (ML) based intelligence into wireless communication networks. The purpose of introducing AI/ML spans not only to increase performance of existing networks, but also to optimize and/or steer various network components to a certain key performance indicator (KPI) of interest in an efficient and elegant way.

Currently, there are many use cases being considered for such AI/ML based intelligence. Among them, Massive MIMO (mMIMO) optimization has been identified as one of the key enablers. Specifically, non-grid of beams (Non-GoB) beamforming approaches have been identified as an important class of beamforming algorithms for 5G mMIMO deployments.

### BRIEF DESCRIPTION OF THE DRAWINGS

FIG. 1A depicts an embodiment of a system including base stations, user equipment, and cloud-based computing and data services interconnected via a communication network;

FIG. 1B illustrates another embodiment of a network in accordance with various embodiments such as the network in FIG. 1A;

FIG. 2A provides an embodiment of a high-level view of an Open RAN (O-RAN) architecture;

FIG. 2B shows an O-RAN logical architecture corresponding to the O-RAN architecture of FIG. 2A;

FIG. 3 illustrates an embodiment of a network in accordance with various embodiments;

FIG. 4 illustrates an embodiment of a simplified block diagram of artificial (AI)-assisted communication between a UE and a RAN, in accordance with various embodiments;

FIG. 5 is an embodiment of a simplified block diagram of a base station and a user equipment (UE) such as the base stations or RANs, the UEs, and communication networks shown in FIGS. 1A-B, 2A-B, 3, and 4;

FIG. 6 depicts a flowchart of an embodiment for a base station to implement a report service such as the embodiments described in conjunction with FIGS. 1-5;

FIG. 7 depicts a flowchart of an embodiment for a base station to implement a query service such as the embodiments described in conjunction with FIGS. 1-5;

FIG. 8 depicts an embodiment of protocol entities that may be implemented in wireless communication devices;

FIG. 9 illustrates embodiments of the formats of PHY data units (PDUs) that may be transmitted by the PHY device via one or more antennas and be encoded and decoded by a MAC entity such as the processors in FIG. 5, the baseband circuitry in FIGS. 5, 13, and 14 according to some aspects;

FIGS. 10A-B depicts embodiments of communication circuitry such as the components and modules shown in the user equipment and base station shown in FIG. 5;

FIG. 11 depicts an embodiment of a storage medium described herein;

FIG. 12 illustrates an architecture of a system of a network in accordance with some embodiments;

FIG. 13 illustrates example components of a device in accordance with some embodiments such as the base stations and UEs shown in FIGS. 1-12;

FIG. 14 illustrates example interfaces of baseband circuitry in accordance with some embodiments such as the baseband circuitry shown and/or discussed in conjunction with FIGS. 1-13; and

FIG. 15 depicts an embodiment of a block diagram of components to perform functionality described.

### DETAILED DESCRIPTION OF EMBODIMENTS

The following is a detailed description of embodiments depicted in the drawings. The detailed description covers all modifications, equivalents, and alternatives falling within the appended claims.

Recently, the related work has been started in O-RAN and captured some basic requirements for RAN intelligence controller (RIC) and RAN nodes to support this AI/ML based Non-GoB beamforming optimization over E2 interface. For example, UE context information may be available for retrieval from RAN nodes toward the a near real-time RAN intelligence controller (near-RT RIC) over E2 interface using E2SM (E2 Service Model) REPORT service:

| | | |
|---|---|---|
| REQ-E2-MM-FUN5 | E2 shall support retrieval of UE Context | Applicable |
| | Information from E2 node for individual | RIC |
| | UE, e.g.: | services: |
| | UE ID | REPORT |
| | Sounding Reference Signal (SRS) | |
| | Periodicity (TS 38.331) | |
| | Supported REPORT triggers shall | |
| | include: Configuration or | |
| | reconfiguration of the UE Context | |
| | Information | |

In essence, feeding UE context related information from RAN nodes to the near-RT RIC over E2 interface is the first step to support various use cases. However, overall the progress is still nascent in O-RAN including the UE context information captured for non-GoB beamforming optimization. For example,
RIC is not able to trigger a RAN node to report UE context related information when a new UE pops up.
RIC is not able to trigger a RAN node to report UE context related info when updated or changed in a RAN node.

In a split architecture where an eNB or gNB is split into CU (centralized unit) and DU (distributed unit), RIC is able to retrieve UE contexts of the UEs currently residing under CU, but not able to from DU.

Embodiments herein may provide enhancements to support the above cases, based on O-RAN, “Near-Real-time RAN Intelligent Controller, E2 Service Model (E2SM), RAN Control” v4.0, O-RAN ALLIANCE e.V, (5223), (E2 Service Model—RAN Control). Embodiments may implement context logic circuitry to add:
1) Mechanisms for near-RT RIC to trigger a RAN node to report UE context related information when a new UE associates with the RAN node.
2) Mechanisms for near-RT RIC to trigger a RAN node to report UE context related information when updated or changed in the RAN node.
3) In a split architecture where a RAN node (e.g., eNB or gNB) is split into a CU (centralized unit) and one or more DUs (distributed units), mechanisms for near-RT RIC to retrieve UE context related information from a DU.

Note that many of the mechanisms are based on some E2SM-RC (E2 Service Model—RAN Control) REPORT services and Query services. In accordance with the E2SM-RC, a given RAN Function offers a set of services to be exposed over the E2 (REPORT, INSERT, CONTROL, POLICY, and/or QUERY) using E2AP defined procedures. Each of the E2AP Procedures contains specific E2 Node RAN Function dependent Information Elements (IEs).

For the purposes of this E2 Service Model, E2SM-RC, the E2 Node terminating the E2 Interface is assumed to host one or more instances of the RAN Function “RAN Control” which performs the following functionalities:
E2 REPORT services used to expose RAN control and UE context related information
E2 INSERT services used to suspend RAN control related call processes
E2 CONTROL services used to resume or initiate RAN control related call processes, modify RAN configuration and/or E2 service-related UE context information
E2 POLICY services used to modify the behavior of RAN control related processes
E2 QUERY services used to request and retrieve RAN and/or UE related information
   The E2 REPORT services may selectively support one or more of the following services:
Copy of Complete message (from Network Interface or RRC), used for monitoring POLICY services, data gathering (to populate the Near-RT RIC UE-NIB and/or ML services data pipeline), etc.
Call process outcome with associated information on UE context and/or RAN status information, used for monitoring [CONTROL and] POLICY services, data gathering (to populate the Near-RT RIC UE-NIB and/or ML services data pipeline), etc.
E2 Node Information and Cell related Information, used for monitoring of E2 Node and Cell configuration changes, triggering POLICY deletion, changing notifications (to reset Near-RT RIC optimization services), etc.
UE Information, used for monitoring of UE information changes, triggering E2 Control, location tracking, etc.

Note that the Near-RT RIC UE-NIB is a NIB file maintained by the Near Real-Time RIC that contains and maintains information about UEs associated with E2 nodes.

The E2 QUERY services may selectively support one or more of the following services:
E2 Node related Information retrieval between Near-RT RIC and E2 Node for any data required at Near-RT RIC
UE related Information retrieval between Near-RT RIC and E2 Node for any data required at Near-RT RIC

The enhancements described in this disclosure enable a near-RT RIC to receive and/or retrieve UE context related information from RAN nodes (including split architecture—CUs and DUs) over E2 interface based on various triggering conditions for reports and/or queries, advantageously supporting various AI/ML use cases being discussed in O-RAN.

In some embodiments, the context logic circuitry may provide code, hardware, cloud-based logic, and/or the like to implement trigger-based reports and/or query-based access to UE context information by a near real-time RIC coupled with a cellular system via or radio access networks (RANs) such as evolved NodeBs (eNBs), centralized units (CUs), distributed units (DUs), and/or other access networks (ANs) indirectly and/or directly. In many embodiments, the UE context information may comprise information about UEs newly associated with the gNBs, eNBs, CUs, and/or DUs, as well as any updates or changes to the UE context information such as updates or changes related to an SRS configuration, updates or changes related to a cell group configuration, and/or the like.

The UE context information may comprise information about a UE, services associated with a UE, and/or other RAN parameters. For instance, the RAN parameters may comprise Packet Data Convergence Protocol (PDCP) UE Variables, Radio Link Control (RLC) Unacknowledge Mode (UM) UE Variables, RLC Acknowledge mode (AM) UE Variables, RLC Transparent mode (TM) UE Variables, medium access control (MAC) Variables, Radio Resource Control (RRC) State, UE Identifier Change, Cell Global identifier (ID), UE context, and/or the like. The UE context may comprise, e.g., SRS Configuration. Cell group configuration, a retrieve UE context response message, and/or the like. The SRS configuration (SRS-config information element (IE)) may be defined in TS 38.331 (3GPP “NR; Radio Resource Control (RRC); Protocol specification” Technical Specification (TS) 38.331 V17.5.0 (5223-06)), the Cell group configuration (CellGroupConfig IE) may be defined in TS 38.331, and the retrieve UE context response message content may be defined in TS 38.423 clause 9.1.1.9 (3GPP “NG-RAN; Xn Application Protocol (XnAP)” TS 38.423 V17.5.0 (5223-06)).

In many embodiments, the context logic circuitry may set a trigger for any newly configured UE context and report UE context information in response to the trigger. In many embodiments, the context logic circuitry may set a trigger for any updated or changed UE context and report UE context information in response to the trigger. In some embodiments, the context logic circuitry may respond to queries from the near-RT RIC or other devices with UE context information. In some embodiments, the context logic circuitry may support direct reporting and querying of UE context information at a DU.

In many embodiments, the trigger for new or updated UE context information is an event trigger based on a RIC Event Trigger Definition IE style. The RIC Event Trigger Definition IE style used to detect a UE context related information change from the subscribed E2 Node. The E2 Node can also be configured to detect multiple changes simultaneously and to trigger only when all the configured changes happen or for any logical combination of the configured changes.

In some embodiments, the context logic circuitry may set a trigger for an event for reporting to the near-RT RIC, a UE ID and UE Context Information whenever the SRS configuration (SRS-Config) for a UE is updated. Any change of SRS-Config for a UE (either newly configured or updated) may be defined as event triggering for an E2 Node to supply the (updated) SRS configuration to the near-RT RIC. The Event Trigger Function Style 4 (ETF4) IE (UE Information Change) may be defined to trigger a report of UE context information based on a change of the SRS configuration to indicate that UE context information changed). To accomplish this, the context logic circuitry of the near-RT RIC may setup an event trigger for the UE context information change by configuring the “UE Context Info” IE for the E2SM-RC Event Trigger Definition format 4 (UE Information change), which is shown in Table 9.2.1.1.4 below. Based on the “UE Context Info” IE for the E2SM-RC Event Trigger Definition format 4, the context logic circuitry of the E2 nodes may include a near-RT RIC event trigger definition for a UE context information change to trigger reports by an eNB, CU, and/or a DU to the near-RT RIC. The E2SM-RC Event Trigger Definition Format 4 may comprise UE context info as shown in TABLE 9.2.1.1.4:

TABLE 9.2.1.1.4
E2SM-RC Event Trigger Definition Format 4: UE Information Change

| | | | IE type and | Semantics |
|---|---|---|---|---|
| IE/Group Name | Presence | Range | reference | description |
| Sequence of UE | | 1 . . . | | |
| Information Change | | <maxnoofUEInfoChanges> | | |
| >Event Trigger | M | | 9.3.21 | |
| Condition ID | | | | |
| >CHOICE Trigger | M | | | |
| Type | | | | |
| >>RRC State | | | | |
| >>>RRC State List | | 1 . . . | | |
| | | <maxnoofRRCstate> | | |
| >>>>State Changed | M | | 9.3.37 | |
| To | | | | |
| >>>>Logical OR | O | | 9.3.25 | |
| >>UE Identifier | | | | |
| >>>UE Identifier | M | | INTEGER (1 . . . | Defined in 7.3.5. |
| Change ID | | | 512, . . .) | |
| >>L2 State | | | | Used to set |
| | | | | conditions for |
| | | | | PDCP, RLC and |
| | | | | MAC state variable |
| | | | | reporting |
| >>>Associated L2 | M | | 9.3.29 | RAN Parameters in |
| Variables | | | | Sections 8.1.1.4 and |
| | | | | 8.1.1.8 shall only be |
| | | | | used. |
| >>UE Context Info | | | | |
| >>>Associated UE | M | | 9.3.29 | RAN Parameters in |
| Context Info | | | | Section 8.1.1.17 |
| Variables | | | | |
| >Associated UE Info | O | | 9.3.26 | Indicates applicable |
| | | | | UE(s) for event |
| | | | | triggering (“Any” |
| | | | | UE if not included). |
| >Logical OR | O | | 9.3.25 | |

Note that the range bound maxnoofUEInfoChanges may be a maximum number of UE information changes for which event trigger can be defined. The value is <65535>. The range bound maxnoofRRCstate may be a maximum number of RRC states for which event trigger can be defined. The value is <8>.

Note also that an E2 Node refers to a logical termination of the E2 interface in an AN, such as an O-gNB of a gNB, an O-cNB of an cNB, an O-CU of an CU, or an O-DU of a DU. The E2 interface is an interface connecting the Near-RT RIC and one or more O-CU-CPs, one or more O-CU-UPs, one or more O-DUs, and one or more O-eNBs, and, in some embodiments, one or more O-gNBs. The O-CU-CP is a control plane (CP) interface of the logical E2 node, O-CU, of the RAN node CU and the O-CU-UP is user plane (UP) interface of the logical E2 node, O-CU, of the RAN node CU.

In some embodiments, the context logic circuitry may set a trigger a report to the near-RT RIC after or in response an event that sets a UE Identifier Change ID=1, which indicates that a new UE is connected. Once set, an event for REPORT service is triggered whenever a new UE is configured at the RAN node. In such embodiments, the related REPORT service (i.e. REPORT Style 4) may be enhanced to support UE context related RAN parameters to be used by the corresponding Action Definition Format such as Action Definition Format 1 for the near-RT RIC to indicate to report the UE context related RAN parameters as well as by the corresponding Indication Message Format, such as Indication Message Format 2, to report their actual values of the UE context related RAN parameters. In some embodiments, the context logic circuitry may alternatively implement a new report service for E2 with an existing Event Trigger Style 4 and with the corresponding RAN parameters related to UE context information. In some embodiments, the supported UE Context information changes for event triggering are:
RRC state change
UE identifier change (based on UE ID defined in Section 9.3.10 of the E2SM-RC-R003-v04.00)
RLC/PDCP state variable or MAC state variable change (based on RAN Parameters defined in Sections 8.1.1.4 and 8.1.1.8 of the E2SM-RC-R003-v04.00)
UE context info change

For UE identifier change, the following cases may be supported for event triggering.

TABLE 7.3.5
RIC Event trigger definition IE style 4: UE Information Change

| UE Identifier | UE Identifier | |
|---|---|---|
| Change ID | Change Type | Description |
| 1 | New UE | Triggered when new UE ID is assigned |
| | Connected | for a new UE connected. |
| 2 | UE Handed Over | Triggered when new UE ID is assigned |
| | | due to HO from another node. |
| 3 | UE ID Changed | Triggered when any content of the |
| | | assigned UE ID (based on the definition |
| | | of UE ID in Section 9.3.10 of E2SM- |
| | | RC-R003-v04.00) has changed. |
| 4 | UE ID Removed | Triggered when a UE is released, and |
| | | its UE ID is removed. |

The detection for each UE information change configured may be based on for any UEs, or only for a certain UE or group of UEs as indicated by the Associated UE Info IE if included.

For each information change configured, an Event Trigger Condition ID is assigned so that E2 Node can reply to Near-RT RIC in the RIC INDICATION message to inform which event(s) are the cause for triggering.

This RIC Event Trigger Definition IE style may use RIC Event Trigger Definition IE Format 4 (9.2.1.1.4 of E2SM-RC-R003-v04.00). Note that, unless otherwise indicated, references to section numbers here refer to section numbers of E2SM-RC-R003-v04.00 or a prior or subsequent revision of E2SM-RC-R003.

In many embodiments, a supported RIC report service may include a report service style for an eNB, a CU, and/or a DU to report new or updated UE context information such as a REPORT Service Style 4: UE Information. The report service style may provide UE related information carried in the RIC Indication Message IE (including an indication ID for an action of a RIC control style) along with an associated RIC Indication Header IE (including a name of a control action) to provide information related event trigger conditions. The required information to be provided may be controlled using the associated RIC Action Definition IE parameters (a sequence of one or more parameters including RAN parameter ID and the RAN parameter value type for each of the one or more RAN parameters). The REPORT Service Style 4: UE Information may enable the E2 Node to report, on a per UE basis, UE information comprising:
L2 UE State variable values including
PDCP UE State variables
RLC UE State variables
MAC UE variables.
L3 UE State variable values including
RRC State
UE ID Information
UE ID change information including
Current UE ID
Old UE ID
NI or RRC message which triggered the UE ID change
UE context related information

In many embodiments, context logic circuitry may trigger a report service to report new UE context information or updated UE context information in a report service style, e.g., REPORT Service Style 4 (UE information), by an event trigger such as Event Trigger style 4 (UE Information Change). The RAN Parameters pertaining to “Event Trigger” that are used across multiple service styles are listed here. All RAN Parameters may also be used to define a Policy Condition. The UE context information in an event trigger style may comprise a UE context container and/or an SRS configuration. Such RAN parameters may include:

TABLE 8.1.1.17
UE Context Information

| RAN | | RAN | | RAN | |
|---|---|---|---|---|---|
| Parameter | | Parameter | Key | Parameter | |
| ID | RAN Parameter | Value Type | Flag | Definition | Semantics Description |
| 21501 | Master Node | STRUCTURE | | 8.1.1.11 | |
| 21502 | >gNB Measurements | STRUCTURE | | 8.1.1.15 | |
| 21503 | CHOICE Primary Cell | STRUCTURE | | | |
| | of MCG | | | | |
| 21504 | >NR Cell | STRUCTURE | | 8.1.1.1 | For NR SpCell |
| 21505 | >E-UTRA Cell | STRUCTURE | | 8.1.1.2 | For E-UTRA PCell |
| 21506 | List of Secondary Cells | LIST | | | Scell To Be Setup List IE |
| | of MCG | | | | in TS 38.473 clause |
| | | | | | 9.2.2.1 |
| 21507 | >SCell Item | STRUCTURE | | | Scell To Be Setup Item |
| | | | | | IEs IE in TS 38.473 |
| | | | | | clause 9.2.2.1 |
| 21508 | >>CHOICE SCell | STRUCTURE | | | |
| 21509 | >>>NR Cell | STRUCTURE | | 8.1.1.1 | For NR SCell |
| 21510 | >>>E-UTRA | STRUCTURE | | 8.1.1.2 | For E-UTRA SCell |
| | Cell | | | | |
| 21511 | Secondary Node | STRUCTURE | | 8.1.1.11 | |
| 21512 | >gNB Measurements | STRUCTURE | | 8.1.1.15 | |
| 21513 | CHOICE Primary Cell | STRUCTURE | | | PSCell IE as defined in |
| | of SCG | | | | TS 38.331 or the |
| | | | | | structure defined in TS |
| | | | | | 38.473 clause 9.2.2.1 |
| 21514 | >NR Cell | STRUCTURE | | 8.1.1.1 | |
| 21515 | >E-UTRA Cell | STRUCTURE | | 8.1.1.2 | |
| 21516 | List of Secondary Cells | LIST | | | Scell To Be Setup List IE |
| | of SCG | | | | in TS 38.473 clause |
| | | | | | 9.2.2.1 |
| 21517 | >SCell Item | STRUCTURE | | | Scell To Be Setup Item |
| | | | | | IEs IE in TS 38.473 |
| | | | | | clause 9.2.2.1 |
| 21518 | >>CHOICE SCell | STRUCTURE | | | |
| 21519 | >>>NR Cell | STRUCTURE | | 8.1.1.1 | |
| 21520 | >>>E-UTRA | STRUCTURE | | 8.1.1.2 | |
| | Cell | | | | |
| 21521 | List of PDU Sessions | LIST | | | PDU Session Resources |
| | | | | | To Be Setup List IE in |
| | | | | | TS 38.423 Section |
| | | | | | 9.2.1.1 |
| 21522 | >PDU Session Item | STRUCTURE | | | PDU Session Resources |
| | | | | | To Be Setup Item IE in |
| | | | | | TS 38.423 Section |
| | | | | | 9.2.1.1 |
| 21543 | >>PDU Session ID | ELEMENT | TRUE | PDU | |
| | | | | Session | |
| | | | | ID IE in | |
| | | | | TS | |
| | | | | 38.413 | |
| | | | | Section | |
| | | | | 9.3.1.50 | |
| 21523 | >>PDU Session | STRUCTURE | | 8.1.1.16 | |
| 21524 | >>List of DRBs | LIST | | | DRB to Be Setup List IE |
| | | | | | in TS 38.473 Section |
| | | | | | 9.2.2.1 |
| 21525 | >>>DRB Item | STRUCTURE | | | |
| 21546 | >>>>DRB ID | ELEMENT | TRUE | DRB ID | |
| | | | | IE in TS | |
| | | | | 38.463 | |
| | | | | clause | |
| | | | | 9.3.1.16 | |
| 21547 | >>>>DRB | STRUCTURE | | 8.1.1.5 | |
| 21526 | >>>>List of | LIST | | | QoS Flows Information |
| | QoS flows | | | | To Be Setup IE in TS |
| | mapped to | | | | 38.463 Section 9.3.3.2 |
| | DRB | | | | |
| 21527 | >>>>>QoS | STRUCTURE | | | |
| | Flow Item | | | | |
| 21548 | >>>>>> | ELEMENT | TRUE | QoS | |
| | QoS | | | Flow | |
| | Flow | | | Identifier | |
| | Identifier | | | IE in TS | |
| | | | | 38.413 | |
| | | | | Section | |
| | | | | 9.3.1.51 | |
| 21549 | >>>>>> | STRUCTURE | | 8.1.1.6 | |
| | QoS | | | | |
| | Flow | | | | |
| 21528 | List of Neighbor cells | LIST | | | measResultNeighCells IE |
| | | | | | in TS 38.331 |
| 21529 | >Neighbor Cell Item | STRUCTURE | | | |
| 21530 | >>CHOICE | STRUCTURE | | | |
| | Neighbor Cell | | | | |
| 21531 | >>>NR Cell | STRUCTURE | | 8.1.1.1 | MeasResultNR IE in TS |
| | | | | | 38.331 |
| 21532 | >>>E-UTRA | STRUCTURE | | 8.1.1.2 | MeasResultEUTRA IE in |
| | Cell | | | | TS 38.331 |
| 21540 | UE Context Container | ELEMENT | FALSE | OCTET | The RETRIEVE UE |
| | | | | STRING | CONTEXT RESPONSE |
| | | | | | message content in TS |
| | | | | | 38.423 clause 9.1.1.9. |
| 21541 | SRS Configuration | ELEMENT | FALSE | OCTET | SRS-Config IE defined in |
| | | | | STRING | TS 38.331. |

The context logic circuitry may include RAN parameters for REPORT services in report services styles to report new or updated UE context information from a gNB, an eNB, a CU, and/or a DU, to the near real-time RIC. A report service style, e.g., Report Service Style 4 (UE information), may comprise a parameter, UE context info change, such as:

TABLE 8.2.4
RAN Parameters for Report Service Style 4

| RAN | RAN | RAN | RAN | | RAN | |
|---|---|---|---|---|---|---|
| Parameter | Parameter | Parameter | Parameter | Key | Parameter | Semantics |
| Category | ID | Name | Value Type | Flag | Definition | Description |
| PDCP UE | Defined in Section 8.1.1.8 L2 Bearer State | | | | | |
| Variables | Variables for PDCP State Variables | | | | | |
| RLC UM UE | Defined in Section 8.1.1.8 L2 Bearer State | | | | | |
| Variables | Variables for RLC UM State Variables | | | | | |
| RLC AM UE | Defined in Section 8.1.1.8 L2 Bearer State | | | | | |
| Variables | Variables for RLC AM State Variables | | | | | |
| MAC Variables | 100 | UL MAC CE | ELEMENT | FALSE | OCTET | This shall be |
| | | | | | STRING | used to report |
| | 101 | DL MAC CE | ELEMENT | FALSE | OCTET | MAC CE |
| | | | | | STRING | Structure as |
| | | | | | | per TS |
| | | | | | | 38.321 [26] |
| | | | | | | clause 6.1.3 |
| | 102 | DL Buffer | ELEMENT | FALSE | INTEGER | DL Buffer |
| | | Occupancy | | | | Occupancy |
| | | | | | | at RLC. |
| | | | | | | Expressed as |
| | | | | | | absolute values |
| | | | | | | in terms of |
| | | | | | | Number of |
| | | | | | | Kilo Bytes (KB) |
| RRC State | 510 | Current | ELEMENT | FALSE | Defined in | This shall be |
| | | RRC State | | | Section | used to report |
| | | | | | 9.3.37. | the RRC state |
| | | | | | | before RRC |
| | | | | | | state change. |
| | 522 | RRC State | ELEMENT | FALSE | Defined in | This shall be |
| | | Changed To | | | Section | used to report |
| | | | | | 9.3.37. | new RRC state |
| | | | | | | upon RRC |
| | | | | | | stage change |
| UE Identifier | 520 | RRC | ELEMENT | FALSE | OCTET | This shall be |
| | | Message | | | STRING | used to report |
| | | | | | | the RRC message |
| | | | | | | which triggered |
| | | | | | | RRC state change |
| Change | 300 | Old UE ID | ELEMENT | FALSE | OCTET | Defined in |
| | | | | | STRING | Section 9.3.10. |
| | | | | | | This shall be |
| | | | | | | used to report |
| | | | | | | the old UE ID |
| | | | | | | upon UE ID |
| | | | | | | change E2 Node |
| | | | | | | shall report |
| | | | | | | any available |
| | | | | | | old NI or |
| | | | | | | RRC interface |
| | | | | | | UE identifier |
| | | | | | | within the |
| | | | | | | UEID structure. |
| | 301 | Current | ELEMENT | FALSE | OCTET | Defined in |
| | | UE ID | | | STRING | Section 9.3.10. |
| | | | | | | This shall be |
| | | | | | | used to report |
| | | | | | | the UE ID |
| | | | | | | available at |
| | | | | | | the time of |
| | | | | | | reporting. |
| | 302 | NI | ELEMENT | FALSE | OCTET | This shall be |
| | | Message | | | STRING | used to report |
| | | | | | | the Network |
| | | | | | | Interface |
| | | | | | | message which |
| | | | | | | triggered |
| | | | | | | the UE ID |
| | | | | | | change. |
| Cell Global ID | 400 | Cell | ELEMENT | FALSE | OCTET | Defined in |
| | | Global ID | | | STRING | Section 9.3.36. |
| | | | | | | This shall be |
| | | | | | | used to report |
| | | | | | | the SpCell ID |
| | | | | | | where the UE |
| | | | | | | belongs to |
| | | | | | | during reporting. |

| | |
|---|---|
| UE Context | Defined in Section 8.1.1.17 UE Context |
| Info Change | Information related RAN parameters |

The context logic circuitry may include definitions for information elements (IEs) including an IE for a RAN parameter test condition to compare a particular value of a given RAN parameter with the target value to trigger reports by an eNB, CU, and/or a DU such as the E2SM-RC Event Trigger Definition Format 4: UE Information Change. The IE definition for a RAN parameter test condition may comprise an enumerated IE type and reference including a value change, such as:

TABLE 9.3.31
RAN Parameter Test Condition

| | | | | |
|---|---|---|---|---|
| IE/Group | | | IE type and | Semantics |
| Name | Presence | Range | reference | description |

| | | | |
|---|---|---|---|
| CHOICE RAN | | | |
| Parameter Test | | | |
| Condition | | | |
| >Comparison | M | ENUMERATED | Applies only |
| | | (equal, difference, | when RAN |
| | | greaterthan, | Parameter |
| | | lessthan, contains, | Value is |
| | | starts with, . . .) | present in |
| | | | 9.3.30. |
| >Presence | M | ENUMERATED | Applies only |
| | | (present, configured, | when RAN |
| | | rollover, non- | Parameter |
| | | zero, . . . , value- | Value is not |
| | | change) | present in |
| | | | 9.3.30. |

In some embodiments, the context logic circuitry may use an existing an E2SM-RC REPORT Style for reporting UE context related RAN parameters.

In some embodiments, the context logic circuitry may define a query service for the near-RT RIC to retrieve a number of supported Non-GoB BE modes, which may be on a per cell basis. In such embodiments, the Query Style 1 (E2 Node Information Query) is used and enhanced with new RAN parameter ID (RPID)=3 for “Number of supported Non-GoB beamforming modes”,

In some embodiments, the context logic circuitry may define a query service for the near-RT RIC to retrieve a UE ID and UE Context Information for all the UEs in an E2 node.

The context logic circuitry may include RAN parameters for QUERY services for the near-RT RIC to query a gNB, an eNB, a CU, and/or a DU. The near-RT RIC may periodically, aperiodically, or sporadically query a gNB, an eNB, a CU, and/or a DU via the E2 interface with a query service style, e.g., Query Service Style 1, that comprises a number of supported Non-GoB beamforming modes, such as:

| RAN | RAN | | | |
|---|---|---|---|---|
| Parameter | Parameter | Key | RAN Parameter | |
| ID | Name | Flag | Definition | Semantics Description |
| 1 | Cell Context | FALSE | OCTET STRING | Served Cell Information IE in TS |
| | Information | | | 38.473 clause 9.3.1.10. This |
| | | | | shall be used to report Cell |
| | | | | Context information. |
| 2 | Neighbour | FALSE | 9.3.8 | This shall be used to report |
| | Relation Table | | Neighbour Relation | neighbour |
| | | | Information | relation information of the |
| | | | | serving cells. |
| 3 | Number of | FALSE | INTEGER (0 . . . | This shall be used to report the |
| | supported | | 65535, . . .) | number of Non- Grid of Beams |
| | Non-GoB | | | (Non-GoB) beamforming modes |
| | beamforming | | | supported by the E2 Node for |
| | modes | | | mMIMO Non-GoB |
| | | | | beamforming optimization for |
| | | | | 5G mMIMO deployments. Each |
| | | | | BF mode implies a vendor- |
| | | | | specific proprietary Non-GoB |
| | | | | BF algorithm that are not |
| | | | | standardized, for which each E2 |
| | | | | Node, who supports the Non- |
| | | | | GoB beamforming optimization |
| | | | | feature, provides the number of |
| | | | | different Non-GoB BF mode(s) |
| | | | | supported by its scheduler |
| | | | | indexed from 1 to n. The AI/ML |
| | | | | model for Non-GoB |
| | | | | beamforming optimization is |
| | | | | trained by data and |
| | | | | measurements related to each BF |
| | | | | mode and/or MIMO mode, for |
| | | | | which the trained AI/ML model, |
| | | | | based on collected data, |
| | | | | configures the E2 Node with the |
| | | | | best inferred Non-GoB BF mode |
| | | | | index to be used for each UE, |
| | | | | where such configuration could |
| | | | | be done separately for the case |
| | | | | of Single User- and/or Multi- |
| | | | | user MIMO. If Non-GoB |
| | | | | beamforming optimization is not |
| | | | | supported by a cell of interest, |
| | | | | then the value “0” shall be |
| | | | | replied. |

Various embodiments may be designed to address different technical problems associated populating the near real time RIC with UE context information, capturing UE context information for newly connected UEs, capturing UE context information for connected UEs with updated or changed UE context information, capturing UE context information from a DU, capturing context information for UEs that support non-GoB beamforming modes, capturing UE context information for UEs in response to SRS configuration updates, capturing UE context information for UEs in response to UE context related RAN parameter updates, and/or the like.

Different technical problems such as those discussed above may be addressed by one or more different embodiments. Embodiments may address one or more of these problems associated with populating the near real time RIC with UE context information. For instance, some embodiments that address problems associated with populating the near real time RIC with UE context information may do so by one or more different technical means, such as, determining user equipment (UE) context information associated with a UE, the UE context information comprising new information related to establishment of a new connection with the UE or related to an update of the UE context information for an existing connection with the UE; identifying an event trigger associated with new information; reporting the UE context information to a near-RT RIC via the network interface such as the E2 interface; and/or the like.

Several embodiments comprise systems with multiple processor cores such as central servers, access points, and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, cameras, and the like), and the like. Some embodiments may provide, e.g., indoor and/or outdoor “smart” grid and sensor services. In various embodiments, these devices relate to specific applications such as healthcare, home, commercial office and retail, security, and industrial automation and monitoring applications, as well as vehicle applications (automobiles, self-driving vehicles, airplanes, drones, and the like), and the like.

The techniques disclosed herein may involve transmission of data over one or more wireless connections using one or more wireless mobile broadband technologies. For example, various embodiments may involve transmissions over one or more wireless connections according to one or more 3rd Generation Partnership Project (3GPP), 3GPP Long Term Evolution (LTE), 3GPP LTE-Advanced (LTE-A), 4G LTE, 5G New Radio (NR) and/or 6G, technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally perform wireless communications according to other wireless communications technologies and/or standards. Examples of other wireless communications technologies and/or standards that may be used in various embodiments may include, without limitation, other IEEE wireless communication standards such as the IEEE 802.11-5220, IEEE 802.11ax-5221, IEEE 802.11ay-5221, IEEE 802.11ba-5221, and/or other specifications and standards, such as specifications developed by the Wi-Fi Alliance (WFA) Neighbor Awareness Networking (NAN) Task Group, machine-type communications (MTC) standards such as those embodied in 3GPP Technical Report (TR) 23.887, 3GPP Technical Specification (TS) 22.368, 3GPP TS 23.682, 3GPP TS 36.133, 3GPP TS 36.306, 3GPP TS 36.321, 3GPP TS.331, 3GPP TS 38.133, 3GPP TS 38.306, 3GPP TS 38.321, 38.214, and/or 3GPP TS 38.331, and/or near-field communication (NFC) standards such as standards developed by the NFC Forum, including any revisions, progeny, and/or variants of any of the above. The embodiments are not limited to these examples.

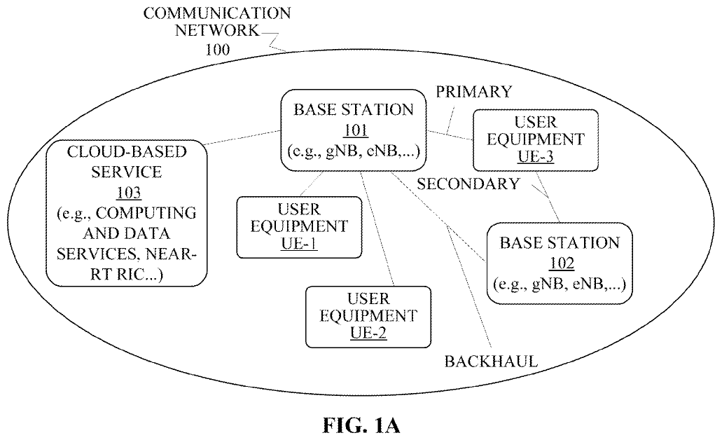

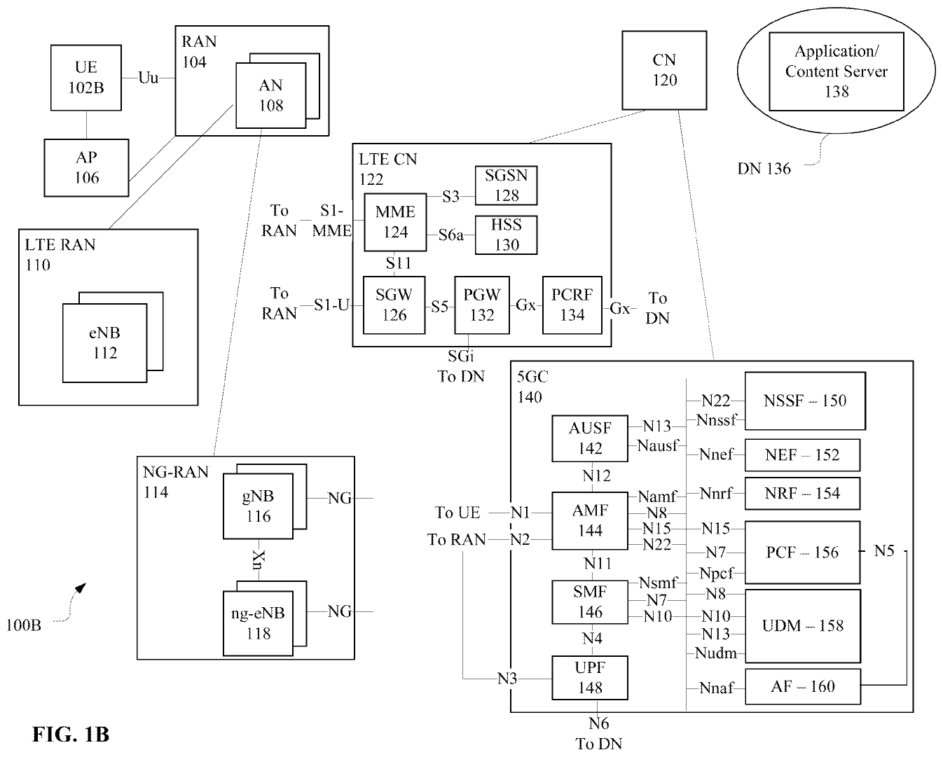

FIG. 1A illustrates a communication network 100 to communicate user equipment context information to a near-RT RIC, which may be part of the cloud-based service 103. The communication network 100 is an Orthogonal Frequency Division Multiplex (OFDM) network comprising a primary base station 101, a secondary base station 102, a cloud-based service 103, a first user equipment UE-1, a second user equipment UE-2, and a third user equipment UE-3. In a 3GPP system based on an Orthogonal Frequency Division Multiple Access (OFDMA) downlink, the radio resource is partitioned into subframes in time domain and each subframe comprises of two slots. Each OFDMA symbol further consists of a count of OFDMA subcarriers in frequency domain depending on the system (or carrier) bandwidth. The basic unit of the resource grid is called Resource Element (RE), which spans an OFDMA subcarrier over one OFDMA symbol. Resource blocks (RBs) comprise a group of REs, where each RB may comprise, e.g., 12 consecutive subcarriers in one slot.

Several physical downlink channels and reference signals use a set of resource elements carrying information originating from higher layers of code. For downlink channels, the Physical Downlink Shared Channel (PDSCH) is the main data-bearing downlink channel, while the Physical Downlink Control Channel (PDCCH) may carry downlink control information (DCI). The control information may include scheduling decision, information related to reference signal information, rules forming the corresponding transport block (TB) to be carried by PDSCH, and power control command. UEs may use cell-specific reference signals (CRS) for the demodulation of control/data channels in non-precoded or codebook-based precoded transmission modes, radio link monitoring and measurements of channel state information (CSI) feedback. UEs may use UE-specific reference signals (DM-RS) for the demodulation of control/data channels in non-codebook-based precoded transmission modes.

The communication network 100 may comprise a cell such as a micro-cell or a macro-cell and the base station 101 may provide wireless service to UEs within the cell. The base station 102 may provide wireless service to UEs within another cell located adjacent to or overlapping the cell. In other embodiments, the communication network 100 may comprise a macro-cell and the base station 102 may operate a smaller cell within the macro-cell such as a micro-cell or a picocell. Other examples of a small cell may include, without limitation, a micro-cell, a femto-cell, or another type of smaller-sized cell.

In various embodiments, the base station 101 and the base station 102 may communicate over a backhaul. In some embodiments, the backhaul may comprise a wired backhaul. In various other embodiments, backhaul may comprise a wireless backhaul. In some embodiments, the backhaul may comprise an Xn interface or a F1 interface, which are interfaces defined between two RAN nodes or base stations such as the backhaul between the base station 101 and the base station 102. The Xn interface is an interface for gNBs and the F1 interface is an interface for gNB-Distributed units (DUs) if the architecture of the communication network 100 is a central unit/distributed unit (CU/DU) architecture. For instance, the base station 101 may comprise a CU and the base station 102 may comprise a DU in some embodiments. In other embodiments, both the base stations 101 and 102 may comprise eNBs or gNBs.

The base stations 101 and 102 may communicate protocol data units (PDUs) via the backhaul. As an example, for the Xn interface, the base station 101 may transmit or share control plane PDUs via an Xn-C interface and may transmit or share data PDUs via a Xn-U interface. For the F1 interface, the base station 101 may transmit or share control plane PDUs via an F1-C interface and may transmit or share data PDUs via a F1-U interface. Note that discussions herein about signaling, sharing, receiving, or transmitting via a Xn interface may refer to signaling, sharing, receiving, or transmitting via the Xn-C interface, the Xn-U interface, or a combination thereof. Similarly, discussions herein about signaling, sharing, receiving, or transmitting via a F1 interface may refer to signaling, sharing, receiving, or transmitting via the F1-C interface, the F1-U interface, or a combination thereof.

In some embodiments, the base stations 101 and 102 may comprise context logic circuitry to communicate user equipment context information to a radio access network (RAN) intelligence controller. The context logic circuitry may reside in the primary base station 101, the secondary base station 102 and the cloud-based service 103. In the present embodiment, the context logic circuitry resides in each of the primary base station 101 and the secondary base station 102.

The cloud-based service 103 may comprise a near-RT RIC. The near-RT RIC may receive, retrieve, store, and maintain UE context information for UEs connected to the base station 101 and the base station 102. The near-RT RIC may store UE context information in files such as Near-RT RIC UE-NIBs and/or may pass the UE context information to machine learning (ML) services and/or other services in a data pipeline for processing.

In some embodiments, the near-RT RIC may receive and/or retrieve UE context information from the base station 101 and 102 via an E2 network interface. The E2 interface may comprise a logical network interface between logical instantiations of O-RAN logic in the context logic circuitry of the base stations 101 and 102 or accessible by the context logic circuitry of the base stations 101 and 102. For instance, the context logic circuitry may comprise hardware and code to perform services associated with the E2 interface and may access local and/or remote logic to perform such services.

While servicing UEs such as the UE-1, UE-2, and UE-3, the base stations 101 and 102 may add new UEs and/or update services or RAN parameters associated with connected UEs. When adding new UEs, the base stations 101 and 102 may generate or associate user context with the newly connected UEs such as RAN parameters, SRS configurations, cell group configurations, and/or the like. Furthermore, the base stations 101 and 102 may update or change the current UE context information associated with UEs having existing connections such as updating or changing RAN parameters, SRS configurations, cell group configurations, and/or the like.

The context logic circuitry of the base stations 101 and 102 may subscribe with the near-RT RIC to perform E2 services or E2 related service for the near-RT RIC such as reporting new and updated UE context information for one or more or all UEs connected with the base stations 101 and 102 in accordance with the subscription with the near-RT RIC. In many embodiments, the context logic circuitry of the base stations 101 and 102 may monitor and detect or identify new or updated UE context information associated with connected UEs and/or may respond to queries from the near-RT RIC and/or associated with the near-RT RIC for reporting new or updated UE context information associated with connected UEs. For instance, the context logic circuitry of the base stations 101 and 102 may comprise event trigger definitions that identify RAN parameters, SRS configurations, cell group configurations, and/or other UE context information that trigger reporting by the base stations 101 and 102 to the near-RT RIC or to destinations identified by the near-RT RIC. In some embodiments, one or more event trigger definitions may identify a single change to a parameter or a configuration to trigger a reporting by the base stations 101 and 102. In some embodiments, one or more event trigger definitions may identify a combination of two or more changes to one or more parameters, one or more configurations, and and/or one or more other UE context information to trigger reporting by the context logic circuitry of the base stations 101 and 102.

In some embodiments, the near-RT RIC or a device or service associated with the near-RT RIC may perform queries to obtain or retrieve UE context information or reports with UE context information from the context logic circuitry of the base stations 101 and 102 via the E2 interface. In such embodiments, for instance, the context logic circuitry of the base stations 101 and 102 may respond to the queries by transmitting UE context information such as UE context information for each UE connected to the base stations 101 and 102 that supports a non-grid of beams (non-GoB) mode for beamforming.

FIG. 1B illustrates an embodiment of a network 100B in accordance with various embodiments such as the network 100 in FIG. 1A. The network 100B may operate in a manner consistent with 3GPP technical specifications for LTE or 5G/NR systems as well as O-RAN specifications such as O-RAN “Near-Real-time RAN Intelligent Controller, E2 Service Model (E2SM), RAN Control”. However, the example embodiments are not limited in this regard and the described embodiments may apply to other networks that benefit from the principles described herein, such as future 3GPP systems, or the like.

The network 100B may include a UE 102B, which may include any mobile or non-mobile computing device designed to communicate with a RAN 104 via an over-the-air connection. The UE 102B may be communicatively coupled with the RAN 104 by a Uu interface. The UE 102B may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 100B may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 102B may additionally communicate with an AP 106 via an over-the-air connection. The AP 106 may manage a WLAN connection, which may serve to offload some/all network traffic from the RAN 104. The connection between the UE 102B and the AP 106 may be consistent with any IEEE 802.11 protocol, wherein the AP 106 could be a wireless fidelity (Wi-Fi®) router. In some embodiments, the UE 102B, RAN 104, and AP 106 may utilize cellular-WLAN aggregation (for example, LWA/LWIP). Cellular-WLAN aggregation may involve the UE 102B being configured by the RAN 104 to utilize both cellular radio resources and WLAN resources.

The RAN 104 may include one or more access nodes, for example, AN 108. AN 108 may terminate air-interface protocols for the UE 102B by providing access stratum protocols including RRC, PDCP, RLC, MAC, and L1 protocols. In this manner, the AN 108 may enable data/voice connectivity between CN 120 and the UE 102B. In some embodiments, the AN 108 may be implemented in a discrete device or as one or more software entities running on server computers as part of, for example, a virtual network, which may be referred to as a CRAN or virtual baseband unit pool. The AN 108 be referred to as a BS, gNB, RAN node, eNB, ng-eNB, NodeB, RSU, TRxP, TRP, etc. The AN 108 may be a macrocell base station or a low power base station for providing femtocells, picocells or other like cells having smaller coverage areas, smaller user capacity, or higher bandwidth compared to macrocells.

In embodiments in which the RAN 104 includes a plurality of ANs, they may be coupled with one another via an X2 interface (if the RAN 104 is an LTE RAN) or an Xn interface (if the RAN 104 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 104 may each manage one or more cells, cell groups, component carriers, etc. to provide the UE 102B with an air interface for network access. The UE 102B may be simultaneously connected with a plurality of cells provided by the same or different ANs of the RAN 104. For example, the UE 102B and RAN 104 may use carrier aggregation to allow the UE 102B to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 104 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 102B or AN 108 may be or act as an RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 104 may be an LTE RAN 110 with eNBs, for example, eNB 112. The LTE RAN 110 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 104 may be an NG-RAN 114 with gNBs, for example, gNB 116, or ng-eNBs, for example, ng-eNB 118. The gNB 116 may connect with 5G-enabled UEs using a 5G NR interface. The gNB 116 may connect with a 5G core through an NG interface, which may include an N2 interface or an N3 interface. The ng-eNB 118 may also connect with the 5G core through an NG interface, but may connect with a UE via an LTE air interface. The gNB 116 and the ng-eNB 118 may connect with each other over an Xn interface.

In some embodiments, the NG interface may be split into two parts, an NG user plane (NG-U) interface, which carries traffic data between the nodes of the NG-RAN 114 and a UPF 148 (e.g., N3 interface), and an NG control plane (NG-C) interface, which is a signaling interface between the nodes of the NG-RAN 114 and an AMF 144 (e.g., N2 interface).

The NG-RAN 114 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CST-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operate on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 102B can be configured with multiple BWPs where each BWP configuration has a different SCS. When a BWP change is indicated to the UE 102B, the SCS of the transmission is changed as well. Another use case example of BWP is related to power saving. In particular, multiple BWPs can be configured for the UE 102B with different amount of frequency resources (for example, PRBs) to support data transmission under different traffic loading scenarios. A BWP containing a smaller number of PRBs can be used for data transmission with small traffic load while allowing power saving at the UE 102B and in some cases at the gNB 116. A BWP containing a larger number of PRBs can be used for scenarios with higher traffic load.

The RAN 104 is communicatively coupled to CN 120 that includes network elements to provide various functions to support data and telecommunications services to customers/subscribers (for example, users of UE 102B). The components of the CN 120 may be implemented in one physical node or separate physical nodes. In some embodiments, NFV may be utilized to virtualize any or all of the functions provided by the network elements of the CN 120 onto physical compute/storage resources in servers, switches, etc. A logical instantiation of the CN 120 may be referred to as a network slice, and a logical instantiation of a portion of the CN 120 may be referred to as a network sub-slice.

In some embodiments, the CN 120 may be an LTE CN 122, which may also be referred to as an EPC. The LTE CN 122 may include MME 124, SGW 126, SGSN 128, HSS 130, PGW 132, and PCRF 134 coupled with one another over interfaces (or “reference points”) as shown. Functions of the elements of the LTE CN 122 may be briefly introduced as follows.

The MME 124 may implement mobility management functions to track a current location of the UE 102B to facilitate paging, bearer activation/deactivation, handovers, gateway selection, authentication, etc.

The SGW 126 may terminate an S1 interface toward the RAN and route data packets between the RAN and the LTE CN 122. The SGW 126 may be a local mobility anchor point for inter-RAN node handovers and also may provide an anchor for inter-3GPP mobility. Other responsibilities may include lawful intercept, charging, and some policy enforcement.

The SGSN 128 may track a location of the UE 102B and perform security functions and access control. In addition, the SGSN 128 may perform inter-EPC node signaling for mobility between different RAT networks; PDN and S-GW selection as specified by MME 124; MME selection for handovers; etc. The S3 reference point between the MME 124 and the SGSN 128 may enable user and bearer information exchange for inter-3GPP access network mobility in idle/active states.

The HSS 130 may include a database for network users, including subscription-related information to support the network entities' handling of communication sessions. The HSS 130 can provide support for routing/roaming, authentication, authorization, naming/addressing resolution, location dependencies, etc. An S6a reference point between the HSS 130 and the MME 124 may enable transfer of subscription and authentication data for authenticating/authorizing user access to the LTE CN 120.

The PGW 132 may terminate an SGi interface toward a data network (DN) 136 that may include an application/content server 138. The PGW 132 may route data packets between the LTE CN 122 and the data network 136. The PGW 132 may be coupled with the SGW 126 by an S5 reference point to facilitate user plane tunneling and tunnel management. The PGW 132 may further include a node for policy enforcement and charging data collection (for example, PCEF). Additionally, the SGi reference point between the PGW 132 and the data network 136 may be an operator external public, a private PDN, or an intra-operator packet data network, for example, for provision of IMS services. The PGW 132 may be coupled with a PCRF 134 via a Gx reference point.

The PCRF 134 is the policy and charging control element of the LTE CN 122. The PCRF 134 may be communicatively coupled to the app/content server 138 to determine appropriate QoS and charging parameters for service flows. The PCRF 132 may provision associated rules into a PCEF (via Gx reference point) with appropriate TFT and QCI.

In some embodiments, the CN 120 may be a 5GC 140. The 5GC 140 may include an AUSF 142, AMF 144, SMF 146, UPF 148, NSSF 150, NEF 152, NRF 154, PCF 156, UDM 158, and AF 160 coupled with one another over interfaces (or “reference points”) as shown. Functions of the elements of the 5GC 140 may be briefly introduced as follows.

The AUSF 142 may store data for authentication of UE 102B and handle authentication-related functionality. The AUSF 142 may facilitate a common authentication framework for various access types. In addition to communicating with other elements of the 5GC 140 over reference points as shown, the AUSF 142 may exhibit an Nausf service-based interface.

The AMF 144 may allow other functions of the 5GC 140 to communicate with the UE 102B and the RAN 104 and to subscribe to notifications about mobility events with respect to the UE 102B. The AMF 144 may be responsible for registration management (for example, for registering UE 102B), connection management, reachability management, mobility management, lawful interception of AMF-related events, and access authentication and authorization. The AMF 144 may provide transport for SM messages between the UE 102B and the SMF 146, and act as a transparent proxy for routing SM messages. AMF 144 may also provide transport for SMS messages between UE 102B and an SMSF. AMF 144 may interact with the AUSF 142 and the UE 102B to perform various security anchor and context management functions. Furthermore, AMF 144 may be a termination point of a RAN CP interface, which may include or be an N2 reference point between the RAN 104 and the AMF 144; and the AMF 144 may be a termination point of NAS (N1) signaling, and perform NAS ciphering and integrity protection. AMF 144 may also support NAS signaling with the UE 102B over an N3 IWF interface.

The SMF 146 may be responsible for SM (for example, session establishment, tunnel management between UPF 148 and AN 108); UE IP address allocation and management (including optional authorization); selection and control of UP function; configuring traffic steering at UPF 148 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 144 over N2 to AN 108; and determining SSC mode of a session. SM may refer to management of a PDU session, and a PDU session or “session” may refer to a PDU connectivity service that provides or enables the exchange of PDUs between the UE 102B and the data network 136.

The UPF 148 may act as an anchor point for intra-RAT and inter-RAT mobility, an external PDU session point of interconnect to data network 136, and a branching point to support multi-homed PDU session. The UPF 148 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 148 may include an uplink classifier to support routing traffic flows to a data network.

The NSSF 150 may select a set of network slice instances serving the UE 102B. The NSSF 150 may also determine allowed NSSAI and the mapping to the subscribed S-NSSAIs, if needed. The NSSF 150 may also determine the AMF set to be used to serve the UE 102B, or a list of candidate AMFs based on a suitable configuration and possibly by querying the NRF 154. The selection of a set of network slice instances for the UE 102B may be triggered by the AMF 144 with which the UE 102B is registered by interacting with the NSSF 150, which may lead to a change of AMF. The NSSF 150 may interact with the AMF 144 via an N22 reference point; and may communicate with another NSSF in a visited network via an N31 reference point (not shown). Additionally, the NSSF 150 may exhibit an Nnssf service-based interface.

The NEF 152 may securely expose services and capabilities provided by 3GPP network functions for third party, internal exposure/re-exposure, AFs (e.g., AF 160), edge computing or fog computing systems, etc. In such embodiments, the NEF 152 may authenticate, authorize, or throttle the AFs. NEF 152 may also translate information exchanged with the AF 160 and information exchanged with internal network functions. For example, the NEF 152 may translate between an AF-Service-Identifier and an internal 5GC information. NEF 152 may also receive information from other NFs based on exposed capabilities of other NFs. This information may be stored at the NEF 152 as structured data, or at a data storage NF using standardized interfaces. The stored information can then be re-exposed by the NEF 152 to other NFs and AFs, or used for other purposes such as analytics. Additionally, the NEF 152 may exhibit an Nnef service-based interface.

The NRF 154 may support service discovery functions, receive NF discovery requests from NF instances, and provide the information of the discovered NF instances to the NF instances. NRF 154 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 154 may exhibit the Nnrf service-based interface.

The PCF 156 may provide policy rules to control plane functions to enforce them, and may also support unified policy framework to govern network behavior. The PCF 156 may also implement a front end to access subscription information relevant for policy decisions in a UDR of the UDM 158. In addition to communicating with functions over reference points as shown, the PCF 156 exhibit an Npcf service-based interface.

The UDM 158 may handle subscription-related information to support the network entities' handling of communication sessions, and may store subscription data of UE 102B. For example, subscription data may be communicated via an N8 reference point between the UDM 158 and the AMF 144. The UDM 158 may include two parts, an application front end and a UDR. The UDR may store subscription data and policy data for the UDM 158 and the PCF 156, and/or structured data for exposure and application data (including PFDs for application detection, application request information for multiple UEs 102B) for the NEF 152. The Nudr service-based interface may be exhibited by the UDR 546 to allow the UDM 158, PCF 156, and NEF 152 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 158 may exhibit the Nudm service-based interface.

The AF 160 may provide application influence on traffic routing, provide access to NEF, and interact with the policy framework for policy control.

In some embodiments, the 5GC 140 may enable edge computing by selecting operator/3rd party services to be geographically close to a point that the UE 102B is attached to the network. This may reduce latency and load on the network. To provide edge-computing implementations, the 5GC 140 may select a UPF 148 close to the UE 102B and execute traffic steering from the UPF 148 to data network 136 via the N6 interface. This may be based on the UE subscription data, UE location, and information provided by the AF 160. In this way, the AF 160 may influence UPF (re)selection and traffic routing. Based on operator deployment, when AF 160 is considered to be a trusted entity, the network operator may permit AF 160 to interact directly with relevant NFs. Additionally, the AF 160 may exhibit a Naf service-based interface.

The data network 136 may represent various network operator services, Internet access, or third-party services that may be provided by one or more servers including, for example, application/content server 138.

In some embodiments, the RAN 104 or one or more AN 108 may subscribe to a near-RT RIC of the RAN 104. As part of the subscription with the near-RT RIC, the RAN 104 or the one or more AN 108 may perform services such as report services and query services for the near-RT RIC. The reporting service may involve reporting UE context for one or more of the UEs 102B connected to the RAN 104 or one or more AN 108. For instance, the RAN 104 or one or more AN 108 may report UE context information for newly connected UEs and may report updated or revised UE context information of UEs with existing connections to the RAN 104 or one or more AN 108. In many embodiments, the RAN 104 or one or more AN 108 may include an event trigger such as an Event Trigger Definition Format 4. The Event Trigger Definition Format 4 may comprise a UE Identifier change ID equal to 1 to indicate a new UE connected. The Event Trigger Definition Format 4 may comprise a UE Identifier change ID equal to 3 to indicate a UE ID changed.

In many embodiments, the RAN 104 or one or more AN 108 may report UE context information for connected UEs response to queries via a E2 interface from or on behalf of the near-RT RIC. In many embodiments, the RAN 104 or one or more AN 108 may include a query definition such as the Query Style 1 (E2 Node Information Query) with a new RAN parameter ID (RPID)=3 for “Number of supported Non-GoB beamforming modes”. The Query Style 1 may provoke reporting by the RAN 104 or one or more AN 108 of connected UEs that supported Non-GoB beamforming modes.

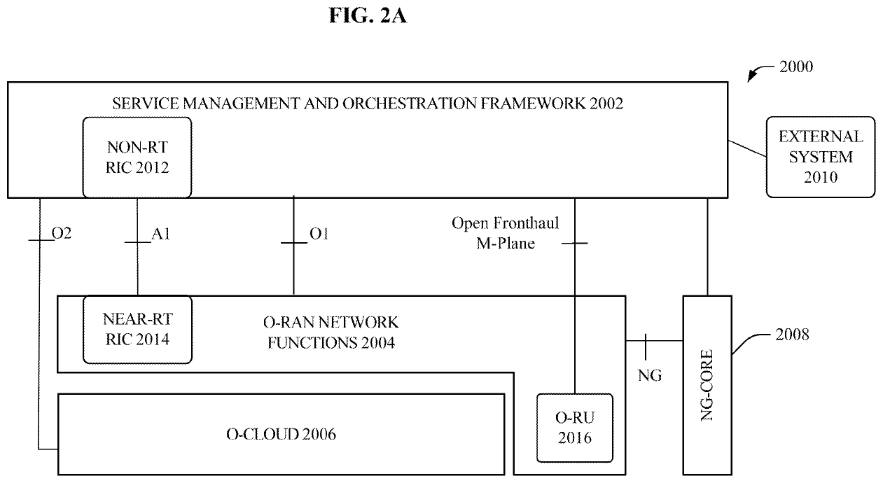

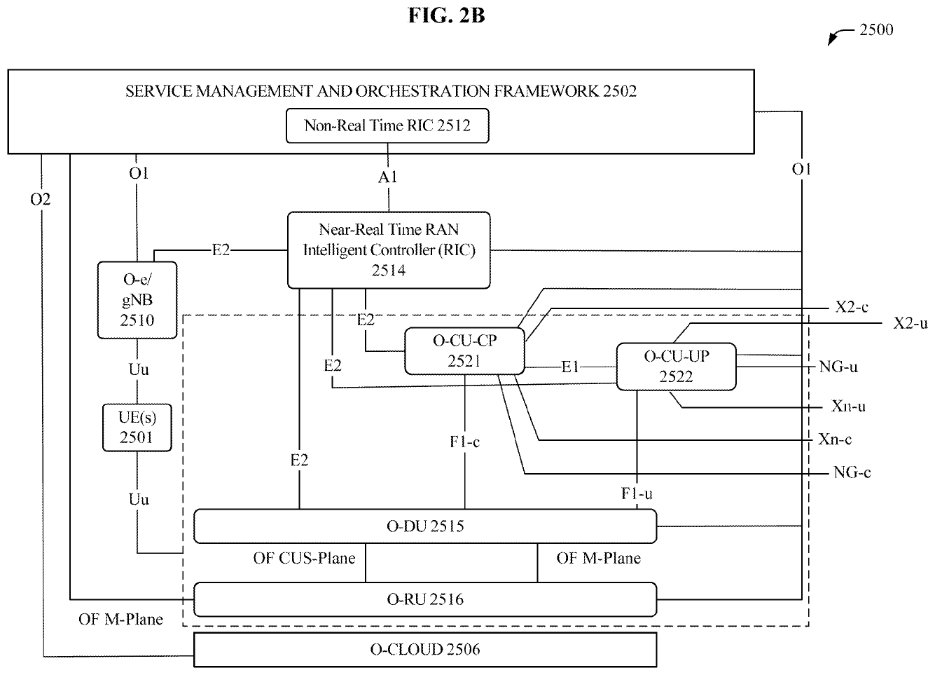

FIG. 2A provides an embodiment of a high-level view of an Open RAN (O-RAN) architecture 2000. The O-RAN architecture 2000 includes four O-RAN defined interfaces—namely, the A1 interface, the O1 interface, the O2 interface, and the Open Fronthaul Management (M)-plane interface—which connect the Service Management and Orchestration (SMO) framework 1522 to O-RAN network functions (NFs) 2004 and the O-Cloud 2006. The SMO 1522 (described in [O13]) also connects with an external system 2010, which provides enrichment data to the SMO 1522. FIG. 2A also illustrates that the A1 interface terminates at an O-RAN Non-Real Time (RT) RAN Intelligent Controller (RIC) 2012 in or at the SMO 1522 and at the O-RAN Near-RT RIC 2014 in or at the O-RAN NFs 2004. The O-RAN NFs 2004 can be VNFs such as VMs or containers, sitting above the O-Cloud 2006 and/or Physical Network Functions (PNFs) utilizing customized hardware. All O-RAN NFs 2004 are expected to support the O1 interface when interfacing the SMO framework 1522. The O-RAN NFs 2004 connect to the NG-Core 2008 via the NG interface (which is a 3GPP defined interface). The Open Fronthaul M-plane interface between the SMO 1522 and the O-RAN Radio Unit (O-RU) 2016 supports the O-RU 2016 management in the O-RAN hybrid model as specified in [O16]. The Open Fronthaul M-plane interface is an optional interface to the SMO 1522 that is included for backward compatibility purposes as per [O16], and is intended for management of the O-RU 2016 in hybrid mode only. The management architecture of flat mode [O12] and its relation to the O1 interface for the O-RU 2016 is for future study. The O-RU 2016 termination of the O1 interface towards the SMO 1522 as specified in [O12].

FIG. 2B shows an embodiment, of an O-RAN logical architecture 2500 corresponding to the O-RAN architecture 2000 of FIG. 2A. In FIG. 2B, the SMO 2502 corresponds to the SMO 1522, O-Cloud 2506 corresponds to the O-Cloud 2006, the non-RT RIC 2512 corresponds to the non-RT RIC 1572, the near-RT RIC 2514 corresponds to the near-RT RIC 2014, and the O-RU 2516 corresponds to the O-RU 2016 of FIG. 2B, respectively. The O-RAN logical architecture 2500 includes a radio portion and a management portion.

The management portion/side of the architectures 2500 includes the SMO Framework 2502 containing the non-RT RIC 2512, and may include the O-Cloud 2506. The O-Cloud 2506 is a cloud computing platform including a collection of physical infrastructure nodes to host the relevant O-RAN functions (e.g., the near-RT RIC 2514, O-CU-CP 2521, O-CU-UP 2522, and the O-DU 2515), supporting software components (e.g., OSs, VMMs, container runtime engines, ML engines, etc.), and appropriate management and orchestration functions.

The radio portion/side of the logical architecture 2500 includes the near-RT RIC 2514, the O-RAN Distributed Unit (O-DU) 2515, the O-RU 2516, the O-RAN Central Unit—Control Plane (O-CU-CP) 2521, and the O-RAN Central Unit—User Plane (O-CU-UP) 2522 functions. The radio portion/side of the logical architecture 2500 may also include the O-c/gNB 2510.

The O-DU 2515 is a logical node hosting RLC, MAC, and higher PHY layer entities/elements (High-PHY layers) based on a lower layer functional split. The O-RU 2516 is a logical node hosting lower PHY layer entities/elements (Low-PHY layer) (e.g., FFT/iFFT, PRACH extraction, etc.) and RF processing elements based on a lower layer functional split. Virtualization of O-RU 2516 is FFS. The O-CU-CP 2521 is a logical node hosting the RRC and the control plane (CP) part of the PDCP protocol. The O O-CU-UP 2522 is a logical node hosting the user plane part of the PDCP protocol and the SDAP protocol.

An E2 interface terminates at a plurality of E2 nodes. The E2 nodes are logical nodes/entities that terminate the E2 interface. For NR/5G access, the E2 nodes include the O-CU-CP 2521, O-CU-UP 2522, O-DU 2515, or any combination of elements as defined in [O15]. For E-UTRA access the E2 nodes include the O-e/gNB 2510. As shown in FIG. 2B, the E2 interface also connects the O-e/gNB 2510 to the Near-RT RIC 2514. The protocols over E2 interface are based exclusively on Control Plane (CP) protocols. The E2 functions are grouped into the following categories: (a) near-RT RIC 2514 services (REPORT, INSERT, CONTROL, POLICY and Query, as described in [O15]); and (b) near-RT RIC 2514 support functions, which include E2 Interface Management (E2 Setup, E2 Reset, Reporting of General Error Situations, etc.) and Near-RT RIC Service Update (e.g., capability exchange related to the list of E2 Node functions exposed over E2).

FIG. 2B shows the Uu interface between a UE 2501 and O-e/gNB 2510 as well as between the UE 2501 and O-RAN components. The Uu interface is a 3GPP defined interface (see e.g., sections 5.2 and 5.3 of [O07]), which includes a complete protocol stack from L1 to L3 and terminates in the NG-RAN or E-UTRAN. The O-e/gNB 2510 is an LTE eNB [O04], a 5G gNB or ng-eNB [O06] that supports the E2 interface. The O-e/gNB 2510 may be the same or similar as eNB 112, gNB 116, ng-eNB 118, RAN 3008, RAN 1510, or some other base station, RAN, or nodeB discussed previously. The UE 2501 may correspond to UEs 102B, 260, 3002, UE 1505, or some other UE discussed with respect to other figures herein, and/or the like. There may be multiple UEs 2501 and/or multiple O-e/gNB 2510, each of which may be connected to one another the via respective Uu interfaces. Although not shown in FIG. 2B, the O-e/gNB 2510 supports O-DU 2515 and O-RU 2516 functions with an Open Fronthaul interface between them.

The Open Fronthaul (OF) interface(s) is/are between O-DU 2515 and O-RU 2516 functions [O16][O17]. The OF interface(s) includes the Control User Synchronization (CUS) Plane and Management (M) Plane. FIGS. 1C and 1D also show that the O-RU 2516 terminates the OF M-Plane interface towards the O-DU 2515 and optionally towards the SMO 2502 as specified in [O16]. The O-RU 2516 terminates the OF CUS-Plane interface towards the O-DU 2515 and the SMO 2502.

The F1-c interface connects the O-CU-CP 2521 with the O-DU 2515. As defined by 3GPP, the F1-c interface is between the gNB-CU-CP and gNB-DU nodes [O07][O10]. However, for purposes of O-RAN, the F1-c interface is adopted between the O-CU-CP 2521 with the O-DU 2515 functions while reusing the principles and protocol stack defined by 3GPP and the definition of interoperability profile specifications.

The F1 u interface connects the O-CU-UP 2522 with the O-DU 2515. As defined by 3GPP, the F1-u interface is between the gNB-CU-UP and gNB-DU nodes [O07][O10]. However, for purposes of O-RAN, the F1-u interface is adopted between the O-CU-UP 2522 with the O-DU 2515 functions while reusing the principles and protocol stack defined by 3GPP and the definition of interoperability profile specifications.

The NG-c interface is defined by 3GPP as an interface between the gNB-CU-CP and the AMF in the 5GC [O06]. The NG-c is also referred as the N2 interface (see [O06]). The NG-u interface is defined by 3GPP, as an interface between the gNB-CU-UP and the UPF in the 5GC [O06]. The NG-u interface is referred as the N3 interface (see [O06]). In O-RAN, NG-c and NG-u protocol stacks defined by 3GPP are reused and may be adapted for O-RAN purposes.

The X2-c interface is defined in 3GPP for transmitting control plane information between eNBs or between eNB and en-gNB in EN-DC. The X2-u interface is defined in 3GPP for transmitting user plane information between eNBs or between eNB and en-gNB in EN-DC (see e.g., [O05], [O06]). In O-RAN, X2-c and X2-u protocol stacks defined by 3GPP are reused and may be adapted for O-RAN purposes.

The Xn-c interface is defined in 3GPP for transmitting control plane information between gNBs, ng-eNBs, or between an ng-eNB and gNB. The Xn-u interface is defined in 3GPP for transmitting user plane information between gNBs, ng-eNBs, or between ng-eNB and gNB (see e.g., [O06], [O08]). In O-RAN, Xn-c and Xn-u protocol stacks defined by 3GPP are reused and may be adapted for O-RAN purposes.

The E1 interface is defined by 3GPP as being an interface between the gNB-CU-CP (e.g., gNB-CU-CP 3728) and gNB-CU-UP (see e.g., [O07], [O09]). In O-RAN, E1 protocol stacks defined by 3GPP are reused and adapted as being an interface between the O-CU-CP 2521 and the O-CU-UP 2522 functions.

The O-RAN Non-Real Time (RT) RAN Intelligent Controller (RIC) 2512 is a logical function within the SMO framework 1522, 2502 that enables non-real-time control and optimization of RAN elements and resources; AI/machine learning (ML) workflow(s) including model training, inferences, and updates; and policy-based guidance of applications/features in the Near-RT RIC 2514.

The O-RAN near-RT RIC 2514 is a logical function that enables near-real-time control and optimization of RAN elements and resources via fine-grained data collection and actions over the E2 interface. The near-RT RIC 2514 may include one or more AI/ML workflows including model training, inferences, and updates.

The non-RT RIC 2512 can be an ML training host to host the training of one or more ML models. ML training can be performed offline using data collected from the RIC, 0-DU 2515 and O-RU 2516. For supervised learning, non-RT RIC 2512 is part of the SMO 2502, and the ML training host and/or ML model host/actor can be part of the non-RT RIC 2512 and/or the near-RT RIC 2514. For unsupervised learning, the ML training host and ML model host/actor can be part of the non-RT RIC 2512 and/or the near-RT RIC 2514. For reinforcement learning, the ML training host and ML model host/actor may be co-located as part of the non-RT RIC 2512 and/or the near-RT RIC 2514. In some implementations, the non-RT RIC 2512 may request or trigger ML model training in the training hosts regardless of where the model is deployed and executed. ML models may be trained and not currently deployed.

In some implementations, the non-RT RIC 2512 provides a query-able catalog for an ML designer/developer to publish/install trained ML models (e.g., executable software components). In these implementations, the non-RT RIC 2512 may provide discovery mechanism if a particular ML model can be executed in a target ML inference host (MF), and what number and type of ML models can be executed in the MF. For example, there may be three types of ML catalogs made discoverable by the non-RT RIC 2512: a design-time catalog (e.g., residing outside the non-RT RIC 2512 and hosted by some other ML platform(s)), a training/deployment-time catalog (e.g., residing inside the non-RT RIC 2512), and a run-time catalog (e.g., residing inside the non-RT RIC 2512). The non-RT RIC 2512 supports necessary capabilities for ML model inference in support of ML assisted solutions running in the non-RT RIC 2512 or some other ML inference host. These capabilities enable executable software to be installed such as VMs, containers, etc. The non-RT RIC 2512 may also include and/or operate one or more ML engines, which are packaged software executable libraries that provide methods, routines, data types, etc., used to run ML models. The non-RT RIC 2512 may also implement policies to switch and activate ML model instances under different operating conditions.

The non-RT RIC 2512 may be able to access feedback data (e.g., FM and PM statistics) over the O1 interface on ML model performance and perform necessary evaluations. If the ML model fails during runtime, an alarm can be generated as feedback to the non-RT RIC 2512. How well the ML model is performing in terms of prediction accuracy or other operating statistics it produces can also be sent to the non-RT RIC 2512 over O1. The non-RT RIC 2512 can also scale ML model instances running in a target MF over the O1 interface by observing resource utilization in MF. The environment where the ML model instance is running (e.g., the MF) monitors resource utilization of the running ML model. This can be done, for example, using an ORAN-SC component called ResourceMonitor in the near-RT RIC 2514 and/or in the non-RT RIC 2512, which continuously monitors resource utilization. If resources are low or fall below a certain threshold, the runtime environment in the near-RT RIC 2514 and/or the non-RT RIC 2512 provides a scaling mechanism to add more ML instances. The scaling mechanism may include a scaling factor such as a number, percentage, and/or other like data used to scale up/down the number of ML instances. ML model instances running in the target ML inference hosts may be automatically scaled by observing resource utilization in the MF. For example, the Kubernetes® (K8s) runtime environment typically provides an auto-scaling feature.

The A1 interface is between the non-RT RIC 2512 (within or outside the SMO 2502) and the near-RT RIC 2514. The A1 interface supports three types of services as defined in [O14], including a Policy Management Service, an Enrichment Information Service, and ML Model Management Service. A1 policies have the following characteristics compared to persistent configuration [O14]: A1 policies are not critical to traffic; A1 policies have temporary validity; A1 policies may handle individual UE or dynamically defined groups of UEs; A1 policies act within and take precedence over the configuration; and A1 policies are non-persistent, i.e., do not survive a restart of the near-RT RIC.

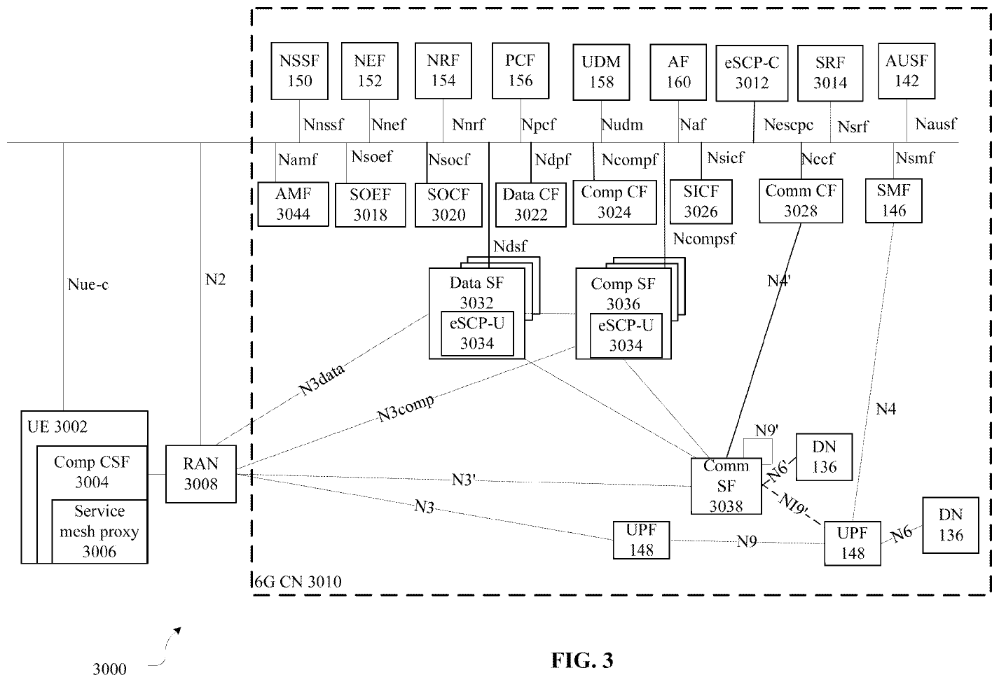

FIG. 3 illustrates an embodiment of a network 3000 in accordance with various embodiments. The network 3000 may operate in a matter consistent with 3GPP technical specifications or technical reports for 6G systems. In some embodiments, the network 3000 may operate concurrently with network 100B. For example, in some embodiments, the network 3000 may share one or more frequency or bandwidth resources with network 100B. As one specific example, a UE (e.g., UE 3002) may be configured to operate in both network 3000 and network 100B. Such configuration may be based on a UE including circuitry configured for communication with frequency and bandwidth resources of both networks 100B and 3000. In general, several elements of network 3000 may share one or more characteristics with elements of network 100B. For the sake of brevity and clarity, such elements may not be repeated in the description of network 3000.

The network 3000 may include a UE 3002, which may include any mobile or non-mobile computing device designed to communicate with a RAN 3008 via an over-the-air connection. The UE 3002 may be similar to, for example, UE 102B. The UE 3002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 3, in some embodiments the network 3000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 3, the UE 3002 may be communicatively coupled with an AP such as AP 106 as described with respect to FIG. 1B. Additionally, although not specifically shown in FIG. 3, in some embodiments the RAN 3008 may include one or more ANs such as AN 108 as described with respect to FIG. 1B. The RAN 3008 and/or the AN of the RAN 3008 may be referred to as a base station (BS), a RAN node, or using some other term or name.

The UE 3002 and the RAN 3008 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 3008 may allow for communication between the UE 3002 and a 6G core network (CN) 3010. Specifically, the RAN 3008 may facilitate the transmission and reception of data between the UE 3002 and the 6G CN 3010. The 6G CN 3010 may include various functions such as NSSF 150, NEF 152, NRF 154, PCF 156, UDM 158, AF 160, SMF 146, and AUSF 142. The 6G CN 3010 may additional include UPF 148 and DN 136 as shown in FIG. 3.

Additionally, the RAN 3008 may include various additional functions that are in addition to, or alternative to, functions of a legacy cellular network such as a 4G or 5G network. Two such functions may include a Compute Control Function (Comp CF) 3024 and a Compute Service Function (Comp SF) 3036. The Comp CF 3024 and the Comp SF 3036 may be parts or functions of the Computing Service Plane. Comp CF 3024 may be a control plane function that provides functionalities such as management of the Comp SF 3036, computing task context generation and management (e.g., create, read, modify, delete), interaction with the underlaying computing infrastructure for computing resource management, etc. Comp SF 3036 may be a user plane function that serves as the gateway to interface computing service users (such as UE 3002) and computing nodes behind a Comp SF instance. Some functionalities of the Comp SF 3036 may include: parse computing service data received from users to compute tasks executable by computing nodes; hold service mesh ingress gateway or service API gateway; service and charging policies enforcement; performance monitoring and telemetry collection, etc. In some embodiments, a Comp SF 3036 instance may serve as the user plane gateway for a cluster of computing nodes. A Comp CF 3024 instance may control one or more Comp SF 3036 instances.

Two other such functions may include a Communication Control Function (Comm CF) 3028 and a Communication Service Function (Comm SF) 3038, which may be parts of the Communication Service Plane. The Comm CF 3028 may be the control plane function for managing the Comm SF 3038, communication sessions creation/configuration/releasing, and managing communication session context. The Comm SF 3038 may be a user plane function for data transport. Comm CF 3028 and Comm SF 3038 may be considered as upgrades of SMF 146 and UPF 148, which were described with respect to a 5G system in FIG. 1B. The upgrades provided by the Comm CF 3028 and the Comm SF 3038 may enable service-aware transport. For legacy (e.g., 4G or 5G) data transport, SMF 146 and UPF 148 may still be used.

Two other such functions may include a Data Control Function (Data CF) 3022 and Data Service Function (Data SF) 3032 may be parts of the Data Service Plane. Data CF 3022 may be a control plane function and provides functionalities such as Data SF 3032 management, Data service creation/configuration/releasing, Data service context management, etc. Data SF 3032 may be a user plane function and serve as the gateway between data service users (such as UE 3002 and the various functions of the 6G CN 3010) and data service endpoints behind the gateway. Specific functionalities may include parse data service user data and forward to corresponding data service endpoints, generate charging data, and report data service status.

Another such function may be the Service Orchestration and Chaining Function (SOCF) 3020, which may discover, orchestrate and chain up communication/computing/data services provided by functions in the network. Upon receiving service requests from users, SOCF 3020 may interact with one or more of Comp CF 3024, Comm CF 3028, and Data CF 3022 to identify Comp SF 3036, Comm SF 3038, and Data SF 3032 instances, configure service resources, and generate the service chain, which could contain multiple Comp SF 3036, Comm SF 3038, and Data SF 3032 instances and their associated computing endpoints. Workload processing and data movement may then be conducted within the generated service chain. The SOCF 3020 may also be responsible for maintaining, updating, and releasing a created service chain.

Another such function may be the service registration function (SRF) 3014, which may act as a registry for system services provided in the user plane such as services provided by service endpoints behind Comp SF 3036 and Data SF 3032 gateways and services provided by the UE 3002. The SRF 3014 may be considered a counterpart of NRF 154, which may act as the registry for network functions.

Other such functions may include an evolved service communication proxy (eSCP) and service infrastructure control function (SICF) 3026, which may provide service communication infrastructure for control plane services and user plane services. The eSCP may be related to the service communication proxy (SCP) of 5G with user plane service communication proxy capabilities being added. The eSCP is therefore expressed in two parts: cCSP-C 3012 and cSCP-U 3034, for control plane service communication proxy and user plane service communication proxy, respectively. The SICF 3026 may control and configure eCSP instances in terms of service traffic routing policies, access rules, load balancing configurations, performance monitoring, etc.

Another such function is the AMF 3044. The AMF 3044 may be similar to 144, but with additional functionality. Specifically, the AMF 3044 may include potential functional repartition, such as move the message forwarding functionality from the AMF 3044 to the RAN 3008.

Another such function is the service orchestration exposure function (SOEF) 3018. The SOEF may be configured to expose service orchestration and chaining services to external users such as applications.

The UE 3002 may include an additional function that is referred to as a computing client service function (comp CSF) 3004. The comp CSF 3004 may have both the control plane functionalities and user plane functionalities, and may interact with corresponding network side functions such as SOCF 3020, Comp CF 3024, Comp SF 3036, Data CF 3022, and/or Data SF 3032 for service discovery, request/response, compute task workload exchange, etc. The Comp CSF 3004 may also work with network side functions to decide on whether a computing task should be run on the UE 3002, the RAN 3008, and/or an element of the 6G CN 3010.

The UE 3002 and/or the Comp CSF 3004 may include a service mesh proxy 3006. The service mesh proxy 3006 may act as a proxy for service-to-service communication in the user plane. Capabilities of the service mesh proxy 3006 may include one or more of addressing, security, load balancing, etc.

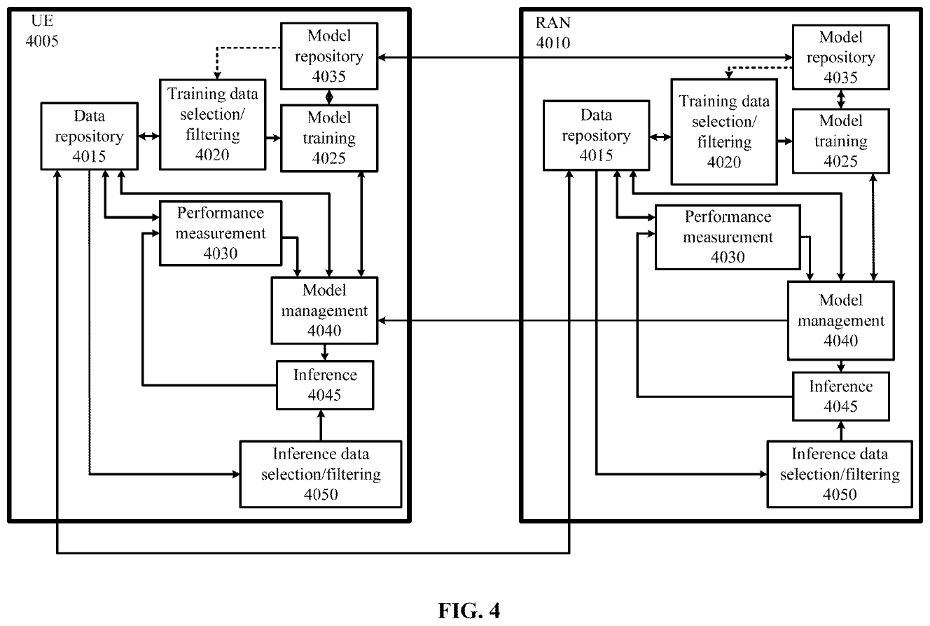

FIG. 4 illustrates an embodiment of a simplified block diagram of artificial (AI)-assisted communication between a UE 4005 and a RAN 4010, in accordance with various embodiments. More specifically, as described in further detail below, AI/machine learning (ML) models may be used or leveraged to facilitate over-the-air communication between UE 4005 and RAN 4010.

One or both of the UE 4005 and the RAN 4010 may operate in a matter consistent with 3GPP technical specifications or technical reports for 6G systems. In some embodiments, the wireless cellular communication between the UE 4005 and the RAN 4010 may be part of, or operate concurrently with, networks 3000, 100B, and/or some other network described herein.

The UE 4005 may be similar to, and share one or more features with, UE 3002, UE 102B, and/or some other UE described herein. The UE 4005 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 4010 may be similar to, and share one or more features with, RAN 114, RAN 3008, and/or some other RAN described herein.

As may be seen in FIG. 4, the AI-related elements of UE 4005 may be similar to the AI-related elements of RAN 4010. For the sake of discussion herein, description of the various elements will be provided from the point of view of the UE 4005, however it will be understood that such discussion or description will apply to equally named/numbered elements of RAN 4010, unless explicitly stated otherwise.

As previously noted, the UE 4005 may include various elements or functions that are related to AI/ML. Such elements may be implemented as hardware, software, firmware, and/or some combination thereof. In embodiments, one or more of the elements may be implemented as part of the same hardware (e.g., chip or multi-processor chip), software (e.g., a computing program), or firmware as another element.

One such element may be a data repository 4015. The data repository 4015 may be responsible for data collection and storage. Specifically, the data repository 4015 may collect and store RAN configuration parameters, measurement data, performance key performance indicators (KPIs), model performance metrics, etc., for model training, update, and inference. More generally, collected data is stored into the repository. Stored data can be discovered and extracted by other elements from the data repository 4015. For example, as may be seen, the inference data selection/filter element 4050 may retrieve data from the data repository 4015. In various embodiments, the UE 4005 may be configured to discover and request data from the data repository 4010 in the RAN, and vice versa. More generally, the data repository 4015 of the UE 4005 may be communicatively coupled with the data repository 4015 of the RAN 4010 such that the respective data repositories of the UE and the RAN may share collected data with one another.

Another such element may be a training data selection/filtering functional block 4020. The training data selection/filter functional block 4020 may be configured to generate training, validation, and testing datasets for model training. Training data may be extracted from the data repository 4015. Data may be selected/filtered based on the specific AI/ML model to be trained. Data may optionally be transformed/augmented/pre-processed (e.g., normalized) before being loaded into datasets. The training data selection/filter functional block 4020 may label data in datasets for supervised learning. The produced datasets may then be fed into model training the model training functional block 4025.

As noted above, another such element may be the model training functional block 4025. This functional block may be responsible for training and updating(re-training) AI/ML models. The selected model may be trained using the fed-in datasets (including training, validation, testing) from the training data selection/filtering functional block. The model training functional block 4025 may produce trained and tested AI/ML models which are ready for deployment. The produced trained and tested models can be stored in a model repository 4035.

The model repository 4035 may be responsible for AI/ML models' (both trained and un-trained) storage and exposure. Trained/updated model(s) may be stored into the model repository 4035. Model and model parameters may be discovered and requested by other functional blocks (e.g., the training data selection/filter functional block 4020 and/or the model training functional block 4025). In some embodiments, the UE 4005 may discover and request AI/ML models from the model repository 4035 of the RAN 4010. Similarly, the RAN 4010 may be able to discover and/or request AI/ML models from the model repository 4035 of the UE 4005. In some embodiments, the RAN 4010 may configure models and/or model parameters in the model repository 4035 of the UE 4005.

Another such element may be a model management functional block 4040. The model management functional block 4040 may be responsible for management of the AI/ML model produced by the model training functional block 4025. Such management functions may include deployment of a trained model, monitoring model performance, etc. In model deployment, the model management functional block 4040 may allocate and schedule hardware and/or software resources for inference, based on received trained and tested models. As used herein, “inference” refers to the process of using trained AT/ML model(s) to generate data analytics, actions, policies, etc. based on input inference data. In performance monitoring, based on wireless performance KPIs and model performance metrics, the model management functional block 4040 may decide to terminate the running model, start model re-training, select another model, etc. In embodiments, the model management functional block 4040 of the RAN 4010 may be able to configure model management policies in the UE 4005 as shown.

Another such element may be an inference data selection/filtering functional block 4050. The inference data selection/filter functional block 4050 may be responsible for generating datasets for model inference at the inference functional block 4045, as described below. Specifically, inference data may be extracted from the data repository 4015. The inference data selection/filter functional block 4050 may select and/or filter the data based on the deployed AI/ML model. Data may be transformed/augmented/pre-processed following the same transformation/augmentation/pre-processing as those in training data selection/filtering as described with respect to functional block 4020. The produced inference dataset may be fed into the inference functional block 4045.

Another such element may be the inference functional block 4045. The inference functional block 4045 may be responsible for executing inference as described above. Specifically, the inference functional block 4045 may consume the inference dataset provided by the inference data selection/filtering functional block 4050, and generate one or more outcomes. Such outcomes may be or include data analytics, actions, policies, etc. The outcome(s) may be provided to the performance measurement functional block 4030.

The performance measurement functional block 4030 may be configured to measure model performance metrics (e.g., accuracy, model bias, run-time latency, etc.) of deployed and executing models based on the inference outcome(s) for monitoring purpose. Model performance data may be stored in the data repository 4015.

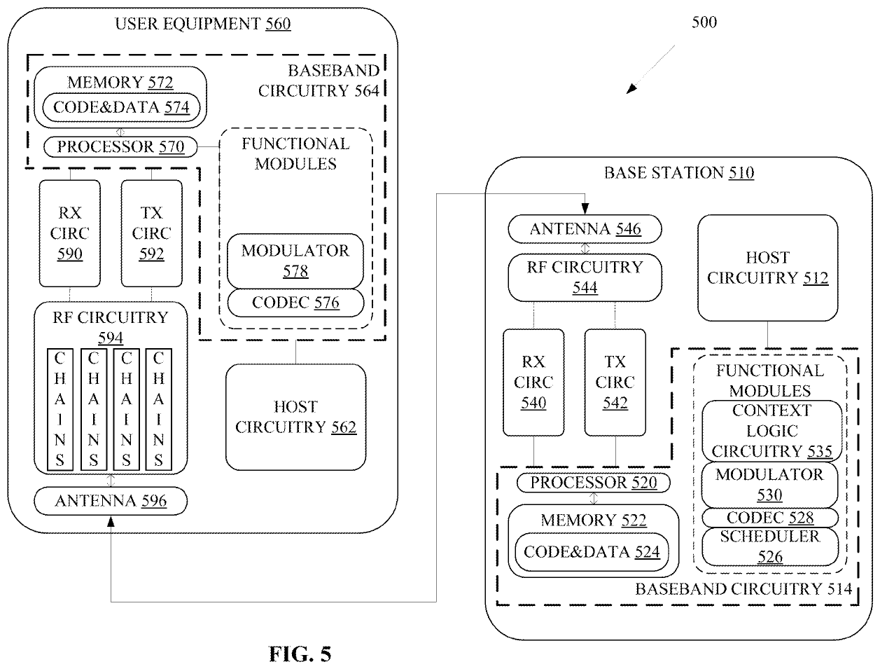

FIG. 5 is an embodiment of a simplified block diagram 500 of a base station 501 and a user equipment (UE) 511 that may carry out certain embodiments of the present invention in a communication network such as the base stations or RANs, the UEs, and communication networks shown in FIGS. 1A-B, 2A-B, 3, and 4. For the base station 510, the antenna 546 transmits and receives radio signals. The RF circuitry 544 coupled with the antenna 546, which is the physical layer of the base station 510, receives RF signals from the antenna 546 and performs operations on the signals such as amplifying signals, and splitting the signals into quadrature phase and in-phase signals. The receiver circuitry 590 may convert the signals to digital baseband signals, or uplink data, and pass the digital in-phase and quadrature phase signals to the processor 520 of the baseband circuitry 514, also referred to as the processing circuitry or baseband processing circuitry, via an interface of the baseband circuitry 514. In other embodiments, analog to digital converters of the processor 520 may convert the in-phase and quadrature phase signals to digital baseband signals.

The transmitter circuitry 592 may convert received, digital baseband signals, or downlink data, from the processor 520 to analog signals. The RF circuitry 544 processes and amplifies the analog signals and converts the analog signals to RF signals and passes the amplified, analog RF signals out to antenna 546.

The processor 520 decodes and processes the digital baseband signals, or uplink data, and invokes different functional modules to perform features in the base station 510. The memory 522 stores program instructions or code and data 524 to control the operations of the base station 510. The host circuitry 512 may execute code such as RRC layer code from the code and data 524 to implement RRC layer functionality and code such as O-gNB, O-eNB, O-CU, or O-DU code to implement E2 interface services for the near-real-time RIC.

A similar configuration exists in UE 560 where the antenna 596 transmits and receives RF signals. The RF circuitry 594, coupled with the antenna 596, receives RF signals from the antenna 596, amplifies the RF signals, and processes the signals to generate analog in-phase and quadrature phase signals. The receiver circuitry 590 processes and converts the analog in-phase and quadrature phase signals to digital baseband signals via an analog to digital converter, or downlink data, and passes the in-phase and quadrature phase signals to processor 570 of the baseband circuitry 564 via an interface of the baseband circuitry 564. In other embodiments, the processor 570 may comprise analog to digital converters to convert the analog in-phase and quadrature phase signals to digital in-phase and quadrature phase signals.

The transmitter circuitry 592 may convert received, digital baseband signals, or downlink data, from the processor 570 to analog signals. The RF circuitry 594 processes and amplifies the analog signals and converts the analog signals to RF signals and passes the amplified, analog RF signals out to antenna 596.

The RF circuitry 594 illustrates multiple RF chains. While the RF circuitry 594 illustrates five RF chains, each UE may have a different number of RF chains and each of the RF chains in the illustration may represent multiple, time domain, receive (RX) chains and transmit (TX) chains. The RX chains and TX chains include circuitry that may operate on or modify the time domain signals transmitted through the time domain chains such as circuitry to insert guard intervals in the TX chains and circuitry to remove guard intervals in the RX chains. For instance, the RF circuitry 594 may include transmitter circuitry and receiver circuitry, which is often called transceiver circuitry. The transmitter circuitry may prepare digital data from the processor 570 for transmission through the antenna 596. In preparation for transmission, the transmitter may encode the data, and modulate the encoded data, and form the modulated, encoded data into Orthogonal Frequency Division Multiplex (OFDM) and/or Orthogonal Frequency Division Multiple Access (OFDMA) symbols. Thereafter, the transmitter may convert the symbols from the frequency domain into the time domain for input into the TX chains. The TX chains may include a chain per subcarrier of the bandwidth of the RF chain and may operate on the time domain signals in the TX chains to prepare them for transmission on the component subcarrier of the RF chain. For wide bandwidth communications, more than one of the RF chains may process the symbols representing the data from the baseband processor(s) simultaneously.

The processor 570 decodes and processes the digital baseband signals, or downlink data, and invokes different functional modules to perform features in the UE 560. The memory 572 stores program instructions or code and data 574 to control the operations of the UE 560. The processor 570 may also execute medium access control (MAC) layer code of the code and data 574 for the UE 560. For instance, the MAC layer code may execute on the processor 570 to cause UL communications to transmit to the base station 510 via one or more of the RF chains of the physical layer (PHY). The PHY is the RF circuitry 594 and associated logic such as some or all the functional modules.

The host circuitry 562 may execute code such as RRC layer code to implement RRC layer functionality and code such as O-gNB, O-eNB, O-CU, or O-DU code to implement E2 interface services for the near-real-time RIC.

The base station 510 and the UE 560 may include several functional modules and circuits to carry out some embodiments. The different functional modules may include circuits or circuitry that code, hardware, or any combination thereof, can configure and implement. Each functional module that can implement functionality as code and processing circuitry or as circuitry configured to perform functionality, may also be referred to as a functional block. For example, the processor 520 (e.g., via executing program code 524) is a functional block to configure and implement the circuitry of the functional modules to allow the base station 510 to schedule (via scheduler 526), encode or decode (via codec 528), modulate or demodulate (via modulator 530), and transmit data to or receive data from the UE 560 via the RF circuitry 544 and the antenna 546.

The processor 570 (e.g., via executing program code in the code and data 574) may be a functional block to configure and implement the circuitry of the functional modules to allow the UE 560 to receive or transmit, de-modulate or modulate (via de-modulator 578), and decode or encode (via codec 576) data accordingly via the RF circuitry 594 and the antenna 596.

The base station 510 may also include a functional module, context logic circuitry 535. The context logic circuitry 535 of the base station 510 may cause the processor 520 and/or the host circuitry 512 to perform actions to determine UE context information for a new connection with a UE such as the UE 560 and/or update UE context information for an existing connection with a UE such as UE 560. The processor 520 and/or the host circuitry 512 (which may include a host processor and a host memory with code and data) may identify an event trigger based on the new or updated UE context information and the event trigger may cause the base station 510 to report the new or updated UE context information to a near real-time RIC, such as the near real-time RIC discussed in conjunction with FIGS. 1-4.

In some embodiments, the processor 520 and/or the host circuitry 512 may further receive a query from the near real-time RIC and generate a response based on a query definition for a query service identifying a set or one or more UEs connected to the base station 510. For instance, the query definition may comprise a Query style 1 with a RAN parameter ID equal to 3, which may cause the base station 510 to report the UE context information for all UEs connected to the base station 510 that support non-GoB beamforming modes.

FIG. 6 depicts a flowchart 6000 of an embodiment for a base station to implement a report service such as the embodiments described in conjunction with FIGS. 1-5. The flowchart 6000 begins with context logic circuitry of an access node of a cellular network receiving an event trigger configuration from the near-RT RIC (element 6002). For instance, the access node (an E2 node) may receive one or more event trigger configurations, such as the E2SM-RC event trigger definition format 4: UE information change, to define event triggers for the access node. The E2SM-RC event trigger definition format 4: UE information change may configure one or more event triggers to cause the access node to report, e.g., UE context information to the near-RT RIC after or in response to detection or determination of one or more changes to the context information identified in the one or more event trigger configurations. Note that the event trigger configurations can set bounds of changes that trigger reporting for one or more parameter or configuration values and may also establish a combination of changes required trigger reporting.

The context logic circuitry of an access node of a cellular network may determine user equipment (UE) context information associated with a UE, the UE context information comprising new information related to establishment of a new connection with the UE or related to an update of the UE context information for an existing connection with the UE (element 6005). The access node may be an E2 node and may comprise a gNB, an eNB, a CU, or a DU to perform E2 services based on a subscription with a near real-time RIC. Note that communications via the E2 interface may be accomplished via any physical network interface of the access node including wireless and wired network interfaces.

After, before, or during the determination of the new information for the UE context, the context logic circuitry of the access node may identify an event trigger associated with new information (element 6010). The context logic circuitry may access event triggers to identify an Event Trigger Definition Format 4. The Event Trigger Definition Format 4 may comprise a UE Identifier change ID equal to 1 to indicate a new UE connected or wherein the Event Trigger Definition Format 4 comprises a UE context information change as defined in, e.g., the “User context info” in the Event Trigger Definition 4 based on the configuration received from the near-RT RIC.

After identifying the event trigger, the context logic circuitry of the access node may report the UE context information to a near-RT RIC via the network (element 6015). In some embodiments, reporting the UE context information comprises generation of a RAN parameter test condition information element to communicate a change of value for one or more RAN parameters to the near-RT RIC. In many embodiments, reporting the UE context information comprises transmission of a report including UE context information for the UE associated with the new information. In many embodiments, the UE context information includes a set of parameters and/or configurations defined for E2 services during subscription by the access node with the near real-time RIC. In some embodiments, the parameters and/or configurations may comprise RAN parameters, SSR configurations, and/or cell group configurations.

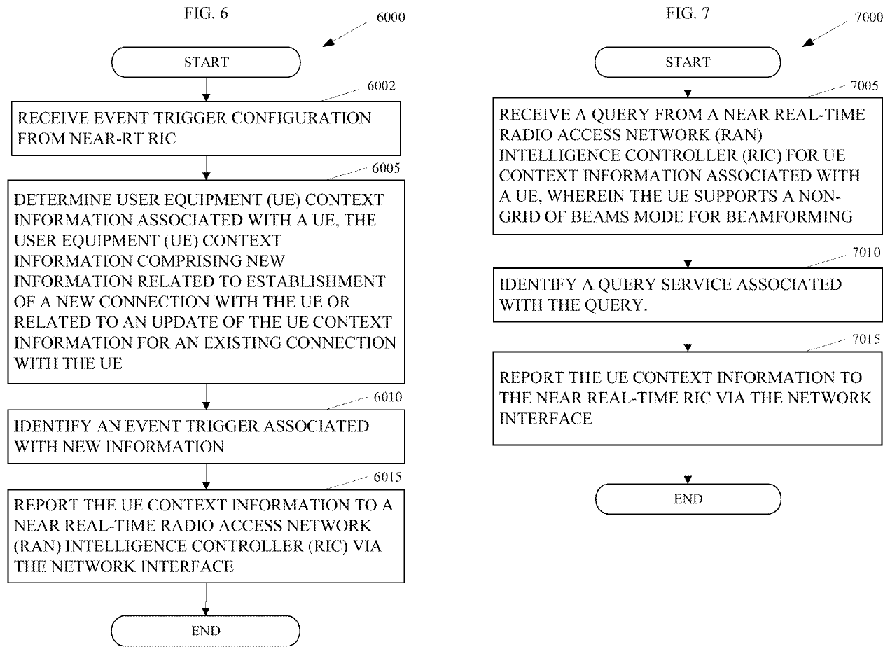

FIG. 7 depicts a flowchart 7000 of an embodiment for a base station to implement a query service such as the embodiments described in conjunction with FIGS. 1-5. The flowchart 7000 begins with context logic circuitry of an access node of a cellular network receiving a query from the near real-time RIC for UE context information associated with a UE, wherein the UE supports a non-grid of beams mode for beamforming (element 7005). The context logic circuitry may parse the query to determine a query service associated with the query (element 7010). In some embodiments, the context logic circuitry may parse the query to determine a RAN parameter ID of 3 in a query style 1 information element. The RAN parameter ID of 3 of the query style 1 information element may indicate that query from the near-RT RIC is for UE context information associated with UEs that support a non-grid of beams mode for beamforming.

In response to the query from the near-RT RIC, the context logic circuitry of the access node may gather and report UE context information for all UEs connected to the access node that comprise UE context information indicating support a non-grid of beams mode for beamforming (element 7015).

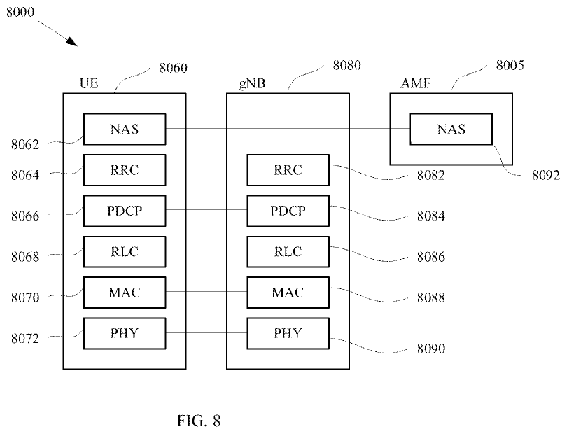

FIG. 8 depicts an embodiment of protocol entities 8000 that may be implemented in wireless communication devices, including one or more of a user equipment (UE) 8060, a base station, which may be termed an evolved node B (eNB), or a new radio, next generation node B (gNB) 8080, and a network function, which may be termed a mobility management entity (MME), or an access and mobility management function (AMF) 8094, according to some aspects. In further embodiments, the NodeB may comprise an xNodeB for a 6^{th} generation or later NodeB.

According to some aspects, gNB 8080 may be implemented as one or more of a dedicated physical device such as a macro-cell, a femto-cell or other suitable device, or in an alternative aspect, may be implemented as one or more software entities running on server computers as part of a virtual network termed a cloud radio access network (CRAN).

According to some aspects, one or more protocol entities that may be implemented in one or more of UE 8060, gNB 8080 and AMF 8094, may be described as implementing all or part of a protocol stack in which the layers are considered to be ordered from lowest to highest in the order physical layer (PHY), medium access control (MAC), radio link control (RLC), packet data convergence protocol (PDCP), radio resource control (RRC) and non-access stratum (NAS). According to some aspects, one or more protocol entities that may be implemented in one or more of UE 8060, gNB 8080 and AMF 8094, may communicate with a respective peer protocol entity that may be implemented on another device, using the services of respective lower layer protocol entities to perform such communication.

According to some aspects, UE PHY layer 8072 and peer entity gNB PHY layer 8090 may communicate using signals transmitted and received via a wireless medium. According to some aspects, UE MAC layer 8070 and peer entity gNB MAC layer 8088 may communicate using the services provided respectively by UE PHY layer 872 and gNB PHY layer 8090. According to some aspects, UE RLC layer 8068 and peer entity gNB RLC layer 8086 may communicate using the services provided respectively by UE MAC layer 8070 and gNB MAC layer 8088. According to some aspects, UE PDCP layer 8066 and peer entity gNB PDCP layer 8084 may communicate using the services provided respectively by UE RLC layer 8068 and 5GNB RLC layer 8086. According to some aspects, UE RRC layer 8064 and gNB RRC layer 8082 may communicate using the services provided respectively by UE PDCP layer 8066 and gNB PDCP layer 8084. According to some aspects, UE NAS 8062 and AMF NAS 8092 may communicate using the services provided respectively by UE RRC layer 8064 and gNB RRC layer 8082.

The PHY layer 8072 and 8090 may transmit or receive information used by the MAC layer 8070 and 8088 over one or more air interfaces. The PHY layer 8072 and 8090 may further perform link adaptation or adaptive modulation and coding (AMC), power control, cell search (e.g., for initial synchronization and handover purposes), and other measurements used by higher layers, such as the RRC layer 8064 and 8082. The PHY layer 8072 and 8090 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 8070 and 8088 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 8068 and 8086 may operate in a plurality of modes of operation, including: Transparent Mode (TM), Unacknowledged Mode (UM), and Acknowledged Mode (AM). The RLC layer 8068 and 8086 may execute transfer of upper layer protocol data units (PDUs), error correction through automatic repeat request (ARQ) for AM data transfers, and concatenation, segmentation and reassembly of RLC SDUs for UM and AM data transfers. The RLC layer 8068 and 8086 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 8066 and 8084 may execute header compression and decompression of Internet Protocol (IP) data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 8064 and 8082 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 8060 and the RAN node, gNB 8080 may utilize a Uu interface (e.g., an LTE-Uu interface) to exchange control plane data via a protocol stack comprising the PHY layer 8072 and 8090, the MAC layer 8070 and 8088, the RLC layer 8068 and 8086, the PDCP layer 8066 and 8084, and the RRC layer 8064 and 8082.

The non-access stratum (NAS) protocols 8092 form the highest stratum of the control plane between the UE 8060 and the AMF 8005. The NAS protocols 8092 support the mobility of the UE 8060 and the session management procedures to establish and maintain IP connectivity between the UE 8060 and the Packet Data Network (PDN) Gateway (P-GW).

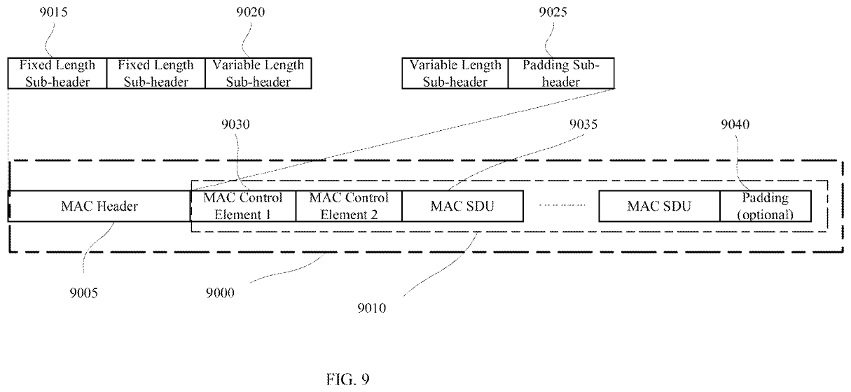

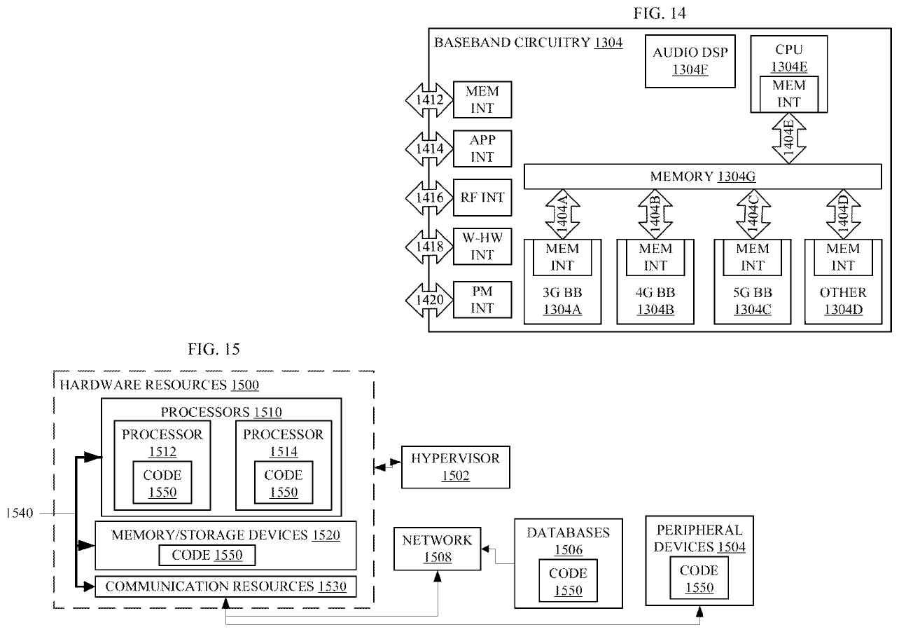

FIG. 9 illustrates embodiments of the formats of PHY data units (PDUs) that may be transmitted by the PHY device via one or more antennas and be encoded and decoded by a MAC entity such as the processors 520 and 570 in FIG. 5, the baseband circuitry 1304 in FIGS. 13 and 14 according to some aspects. In several embodiments, higher layer frames such as a frame comprising an RRC layer information element may transmit from the base station to the UE or vice versa as one or more MAC Service Data Units (MSDUs) in a payload of one or more PDUs in one or more subframes of a radio frame.

According to some aspects, a MAC PDU 9100 may consist of a MAC header 9105 and a MAC payload 9110, the MAC payload consisting of zero or more MAC control elements 9130, zero or more MAC service data unit (SDU) portions 9135 and zero or one padding portion 9140. According to some aspects, MAC header 8105 may consist of one or more MAC sub-headers, each of which may correspond to a MAC payload portion and appear in corresponding order. According to some aspects, each of the zero or more MAC control elements 9130 contained in MAC payload 9110 may correspond to a fixed length sub-header 9115 contained in MAC header 9105. According to some aspects, each of the zero or more MAC SDU portions 9135 contained in MAC payload 9110 may correspond to a variable length sub-header 9120 contained in MAC header 8105. According to some aspects, padding portion 9140 contained in MAC payload 9110 may correspond to a padding sub-header 9125 contained in MAC header 9105.

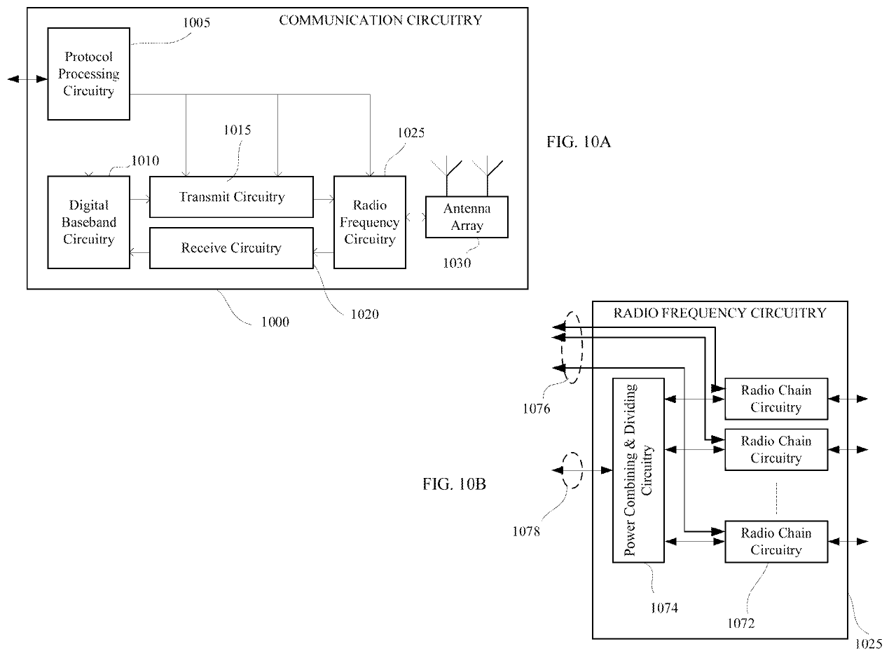

FIG. 10A illustrates an embodiment of communication circuitry 1000 such as the circuitry in the base station 510 and the user equipment 560 shown in FIG. 5. The communication circuitry 1000 is alternatively grouped according to functions. Components as shown in the communication circuitry 1000 are shown here for illustrative purposes and may include other components not shown here in FIG. 10A.

The communication circuitry 1000 may include protocol processing circuitry 1005, which may implement one or more of medium access control (MAC), radio link control (RLC), packet data convergence protocol (PDCP), radio resource control (RRC) and non-access stratum (NAS) functions. The protocol processing circuitry 1005 may include one or more processing cores (not shown) to execute instructions and one or more memory structures (not shown) to store program (code) and data information.

The communication circuitry 1000 may further include digital baseband circuitry 1010, which may implement physical layer (PHY) functions including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

The communication circuitry 1000 may further include transmit circuitry 1015, receive circuitry 1020 and/or antenna array 1030 circuitry.

The communication circuitry 1000 may further include radio frequency (RF) circuitry 1025 such as the RF circuitry 544 and 594 in FIG. 2. In an aspect of an embodiment, RF circuitry 1025 may include multiple parallel RF chains for one or more of transmit or receive functions, each connected to one or more antennas of the antenna array 1030.

In an aspect of the disclosure, the protocol processing circuitry 1005 may include one or more instances of control circuitry (not shown) to provide control functions for one or more of digital baseband circuitry 1010, transmit circuitry 1015, receive circuitry 1020, and/or radio frequency circuitry 1025.

FIG. 10B illustrates an embodiment of radio frequency circuitry 1025 in FIG. 10A according to some aspects such as a RF circuitry 544 and 594 illustrated in FIG. 5. The radio frequency circuitry 1025 may include one or more instances of radio chain circuitry 1072, which in some aspects may include one or more filters, power amplifiers, low noise amplifiers, programmable phase shifters and power supplies (not shown).

The radio frequency circuitry 1025 may include power combining and dividing circuitry 1074. In some aspects, power combining and dividing circuitry 1074 may operate bidirectionally, such that the same physical circuitry may be configured to operate as a power divider when the device is transmitting, and as a power combiner when the device is receiving. In some aspects, power combining and dividing circuitry 1074 may one or more include wholly or partially separate circuitries to perform power dividing when the device is transmitting and power combining when the device is receiving. In some aspects, power combining and dividing circuitry 1074 may include passive circuitry comprising one or more two-way power divider/combiners arranged in a tree. In some aspects, power combining and dividing circuitry 1074 may include active circuitry comprising amplifier circuits.

In some aspects, the radio frequency circuitry 1025 may connect to transmit circuitry 1015 and receive circuitry 1020 in FIG. 10A via one or more radio chain interfaces 1076 or a combined radio chain interface 1078. The combined radio chain interface 1078 may form a wide or very wide bandwidth.

In some aspects, one or more radio chain interfaces 1076 may provide one or more interfaces to one or more receive or transmit signals, each associated with a single antenna structure which may comprise one or more antennas.

In some aspects, the combined radio chain interface 1078 may provide a single interface to one or more receive or transmit signals, each associated with a group of antenna structures comprising one or more antennas.

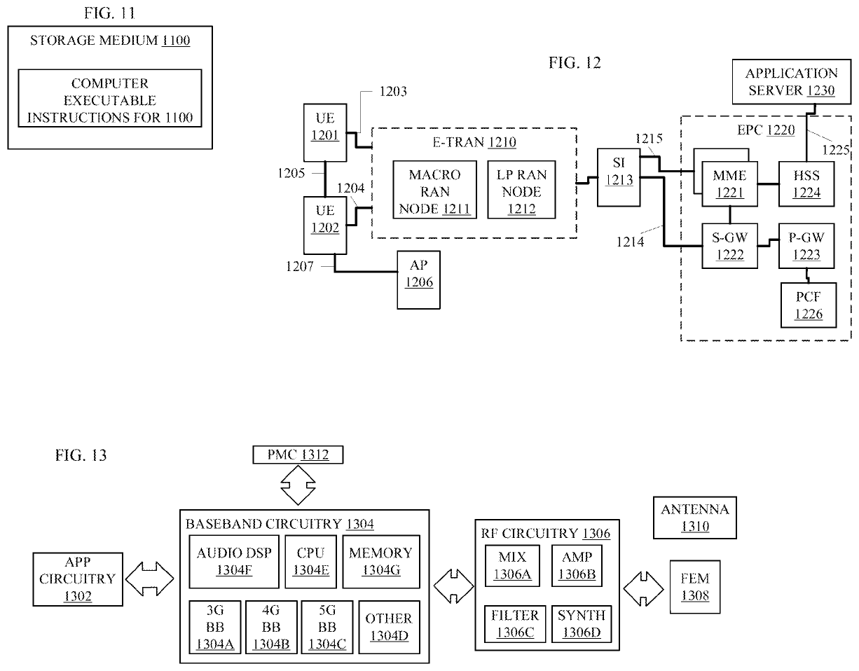

FIG. 11 illustrates an example of a storage medium 1100 to store code and data for execution by any one or more of the processors and/or processing circuitry to perform the functionality of the logic circuitry described herein. Storage medium 1100 may comprise an article of manufacture. In some examples, storage medium 1100 may include any non-transitory computer readable medium or machine-readable medium, such as an optical, magnetic or semiconductor storage. Storage medium 1100 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

FIG. 12 illustrates an architecture of a system 1200 of a network in accordance with some embodiments. The system 1200 is shown to include a user equipment (UE) 1510 and a UE 1522 such as the UEs shown in FIGS. 1-11. The UEs 1510 and 1522 are illustrated as smartphones (e.g., handheld touch screen mobile computing devices connectable to one or more cellular networks) but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 1510 and 1522 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1510 and 1522 may to connect, e.g., communicatively couple, with a radio access network (RAN)—in this embodiment, an Evolved Universal Mobile Telecommunications System (UMTS) Terrestrial Radio Access Network (E-UTRAN) 1210 such as the base stations shown in FIGS. 1-11. The UEs 1510 and 1522 utilize connections 1520 and 1204, respectively, each of which comprises a physical communications interface or layer (discussed in further detail below); in this example, the connections 1520 and 1204 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 1510 and 1522 may further directly exchange communication data via a ProSe interface 1205. The ProSe interface 1205 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1522 is shown to be configured to access an access point (AP) 1206 via connection 1207. The connection 1207 can comprise a local wireless connection, such as a connection consistent with any IEEE 802.11 protocol, wherein the AP 1206 would comprise a wireless fidelity (WiFi®) router. In this example, the AP 1206 is shown to be connected to the Internet without connecting to the core network of the wireless system (described in further detail below). The E-UTRAN 1210 can include one or more access nodes that enable the connections 1520 and 1204. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The E-UTRAN 1210 may include one or more RAN nodes for providing macro-cells, e.g., macro RAN node 1560, and one or more RAN nodes for providing femto-cells or picocells (e.g., cells having smaller coverage areas, smaller user capacity, or higher bandwidth compared to macro-cells), e.g., low power (LP) RAN node 1572.

Any of the RAN nodes 1560 and 1572 can terminate the air interface protocol and can be the first point of contact for the UEs 1510 and 1522. In some embodiments, any of the RAN nodes 1560 and 1572 can fulfill various logical functions for the E-UTRAN 1210 including, but not limited to, radio network controller (RNC) functions such as radio bearer management, uplink and downlink dynamic radio resource management and data packet scheduling, and mobility management.

In accordance with some embodiments, the UEs 1510 and 1522 can be configured to communicate using Orthogonal Frequency-Division Multiplexing (OFDM) communication signals with each other or with any of the RAN nodes 1560 and 1572 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1560 and 1572 to the UEs 1510 and 1522, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink (DL) channels that are conveyed using such resource blocks.

The physical downlink shared channel (PDSCH) may carry user data and higher-layer signaling to the UEs 1510 and 1522. The physical downlink control channel (PDCCH) may carry information about the transport format and resource allocations related to the PDSCH channel, among other things. It may also inform the UEs 1510 and 1522 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the RAN nodes 1560 and 1572 based on channel quality information fed back from any of the UEs 1510 and 1522. The downlink resource assignment information may be sent on the PDCCH used for (e.g., assigned to) each of the UEs 1510 and 1522.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN nodes 1560 and 1572 may communicate with one another and/or with other access nodes in the E-UTRAN 1210 and/or in another RAN via an X2 interface, which is a signaling interface for communicating data packets between ANs. Some other suitable interface for communicating data packets directly between ANs may be used.

The E-UTRAN 1210 is shown to be communicatively coupled to a core network—in this embodiment, an Evolved Packet Core (EPC) network 1220 via an SI interface 1570. In this embodiment the SI interface 1570 is split into two parts: the SI-U interface 1214, which carries traffic data between the RAN nodes 1560 and 1572 and the serving gateway (S-GW) 1222, and the SI-mobility management entity (MME) interface 1215, which is a signaling interface between the RAN nodes 1560 and 1572 and MMEs 1546.

In this embodiment, the EPC network 1220 comprises the MMEs 1546, the S-GW 1222, the Packet Data Network (PDN) Gateway (P-GW) 1223, and a home subscriber server (HSS) 1224. The MMEs 1546 may be similar in function to the control plane of legacy Serving General Packet Radio Service (GPRS) Support Nodes (SGSN). The MMEs 1546 may manage mobility aspects in access such as gateway selection and tracking area list management. The HSS 1224 may comprise a database for network users, including subscription-related information to support the network entities' handling of communication sessions. The EPC network 1220 may comprise one or several HSSs 1224, depending on the number of mobile subscribers, on the capacity of the equipment, on the organization of the network, etc. For example, the HSS 1224 can provide support for routing/roaming, authentication, authorization, naming/addressing resolution, location dependencies, etc.

The S-GW 1222 may terminate the ST interface 1570 towards the E-UTRAN 1210, and routes data packets between the E-UTRAN 1210 and the EPC network 1220. In addition, the S-GW 1222 may be a local mobility anchor point for inter-RAN node handovers and also may provide an anchor for inter-3GPP mobility. Other responsibilities may include lawful intercept, charging, and some policy enforcement.

The P-GW 1223 may terminate an SGi interface toward a PDN. The P-GW 1223 may route data packets between the EPC network 1220 and external networks such as a network including the application server 1230 (alternatively referred to as application function (AF)) via an Internet Protocol (IP) interface 1225. Generally, the application server 1230 may be an element offering applications that use IP bearer resources with the core network (e.g., UMTS Packet Services (PS) domain, LTE PS data services, etc.). In this embodiment, the P-GW 1223 is shown to be communicatively coupled to an application server 1230 via an IP interface 1225. The application server 1230 can also be configured to support one or more communication services (e.g., Voice-over-Internet Protocol (VoIP) sessions, PTT sessions, group communication sessions, social networking services, etc.) for the UEs 1510 and 1522 via the EPC network 1220.

The P-GW 1223 may further be a node for policy enforcement and charging data collection. Policy and Charging Enforcement Function (PCRF) 1226 is the policy and charging control element of the EPC network 1220. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1226 may be communicatively coupled to the application server 1230 via the P-GW 1223. The application server 1230 may signal the PCRF 1226 to indicate a new service flow and select the appropriate Quality of Service (QoS) and charging parameters. The PCRF 1226 may provision this rule into a Policy and Charging Enforcement Function (PCEF) (not shown) with the appropriate traffic flow template (TFT) and QoS class of identifier (QCI), which commences the QoS and charging as specified by the application server 1230.

FIG. 13 illustrates example components of a device 1300 in accordance with some embodiments such as the base stations and UEs shown in FIGS. 1-12. In some embodiments, the device 1300 may include application circuitry 1302, baseband circuitry 1304, Radio Frequency (RF) circuitry 1306, front-end module (FEM) circuitry 1308, one or more antennas 1310, and power management circuitry (PMC) 1312 coupled together at least as shown. The components of the illustrated device 1300 may be included in a UE or a RAN node such as a base station or gNB. In some embodiments, the device 1300 may include less elements (e.g., a RAN node may not utilize application circuitry 1302, and instead include a processor/controller to process IP data received from an EPC). In some embodiments, the device 1300 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1302 may include one or more application processors. For example, the application circuitry 1302 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1300. In some embodiments, processors of application circuitry 1302 may process IP data packets received from an EPC.

The baseband circuitry 1304 may include circuitry such as, but not limited to, one or more single-core or multi-core processors. The baseband circuitry 1304 may include one or more baseband processors or control logic to process baseband signals received from a receive signal path of the RF circuitry 1306 and to generate baseband signals for a transmit signal path of the RF circuitry 1306. The baseband circuitry 1304 may interface with the application circuitry 1302 for generation and processing of the baseband signals and for controlling operations of the RF circuitry 1306. For example, in some embodiments, the baseband circuitry 1304 may include a third generation (3G) baseband processor 1304A, a fourth generation (4G) baseband processor 1304B, a fifth generation (5G) baseband processor 1304C, or other baseband processor(s) 1304D for other existing generations, generations in development or to be developed in the future (e.g., second generation (2G), sixth generation (6G), etc.). In many embodiments, the fourth generation (4G) baseband processor 1304B may include capabilities for generation and processing of the baseband signals for LTE radios and the fifth generation (5G) baseband processor 1304C may capabilities for generation and processing of the baseband signals for NRs.

The baseband circuitry 1304 (e.g., one or more of baseband processors 1304A-D) may handle various radio control functions that enable communication with one or more radio networks via the RF circuitry 1306. In other embodiments, some of or all the functionality of baseband processors 1304A-D may be included in modules stored in the memory 1304G and executed via a Central Processing Unit (CPU) 1304E. The radio control functions may include, but are not limited to, signal modulation/demodulation, encoding/decoding, radio frequency shifting, etc.

In some embodiments, modulation/demodulation circuitry of the baseband circuitry 1304 may include Fast-Fourier Transform (FFT), precoding, or constellation mapping/demapping functionality. In some embodiments, encoding/decoding circuitry of the baseband circuitry 1304 may include convolution, tail-biting convolution, turbo, Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1304 may include one or more audio digital signal processor(s) (DSP) 1304F. The audio DSP(s) 1304F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some of or all the constituent components of the baseband circuitry 1304 and the application circuitry 1302 may be implemented together such as, for example, on a system on a chip (SOC). In some embodiments, the baseband circuitry 1304 may provide for communication compatible with one or more radio technologies. For example, in some embodiments, the baseband circuitry 1304 may support communication with an evolved universal terrestrial radio access network (E-UTRAN) or other wireless metropolitan area networks (WMAN), a wireless local area network (WLAN), a wireless personal area network (WPAN). Embodiments in which the baseband circuitry 1304 is configured to support radio communications of more than one wireless protocol may be referred to as multi-mode baseband circuitry.

The RF circuitry 1306 may enable communication with wireless networks using modulated electromagnetic radiation through a non-solid medium. In various embodiments, the RF circuitry 1306 may include switches, filters, amplifiers, etc. to facilitate the communication with the wireless network. The RF circuitry 1306 may include a receive signal path which may include circuitry to down-convert RF signals received from the FEM circuitry 1308 and provide baseband signals to the baseband circuitry 1304. The RF circuitry 1306 may also include a transmit signal path which may include circuitry to up-convert baseband signals provided by the baseband circuitry 1304 and provide RF output signals to the FEM circuitry 1308 for transmission.

In some embodiments, the receive signal path of the RF circuitry 1306 may include mixer circuitry 1306a, amplifier circuitry 1306b and filter circuitry 1306c. In some embodiments, the transmit signal path of the RF circuitry 1306 may include filter circuitry 1306c and mixer circuitry 1306a. The RF circuitry 1306 may also include synthesizer circuitry 1306d for synthesizing a frequency, or component carrier, for use by the mixer circuitry 1306a of the receive signal path and the transmit signal path. In some embodiments, the mixer circuitry 1306a of the receive signal path may to down-convert RF signals received from the FEM circuitry 1308 based on the synthesized frequency provided by synthesizer circuitry 1306d. The amplifier circuitry 1306b may amplify the down-converted signals and the filter circuitry 1306c may be a low-pass filter (LPF) or band-pass filter (BPF) to remove unwanted signals from the down-converted signals to generate output baseband signals. Output baseband signals may be provided to the baseband circuitry 1304 for further processing.

In some embodiments, the output baseband signals may be zero-frequency baseband signals, although this is not a requirement. In some embodiments, mixer circuitry 1306a of the receive signal path may comprise passive mixers, although the scope of the embodiments is not limited in this respect.

In some embodiments, the mixer circuitry 1306a of the transmit signal path may be configured to up-convert input baseband signals based on the synthesized frequency provided by the synthesizer circuitry 1306d to generate RF output signals for the FEM circuitry 1308. The baseband signals may be provided by the baseband circuitry 1304 and may be filtered by filter circuitry 1306c.

In some embodiments, the mixer circuitry 1306a of the receive signal path and the mixer circuitry 1306a of the transmit signal path may include two or more mixers and may be arranged for quadrature downconversion and upconversion, respectively. In some embodiments, the mixer circuitry 1306a of the receive signal path and the mixer circuitry 1306a of the transmit signal path may include two or more mixers and may be arranged for image rejection (e.g., Hartley image rejection). In some embodiments, the mixer circuitry 1306a of the receive signal path and the mixer circuitry 1306a may be arranged for direct downconversion and direct upconversion, respectively. In some embodiments, the mixer circuitry 1306a of the receive signal path and the mixer circuitry 1306a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1306 may include analog-to-digital converter (ADC) and digital-to-analog converter (DAC) circuitry and the baseband circuitry 1304 may include a digital baseband interface to communicate with the RF circuitry 1306.

In some dual-mode embodiments, a separate radio IC circuitry may be provided for processing signals for each spectrum, although the scope of the embodiments is not limited in this respect.

In some embodiments, the synthesizer circuitry 1306d may be a fractional-N synthesizer or a fractional NIN+ I synthesizer, although the scope of the embodiments is not limited in this respect as other types of frequency synthesizers may be suitable. For example, synthesizer circuitry 1306d may be a delta-sigma synthesizer, a frequency multiplier, or a synthesizer comprising a phase-locked loop with a frequency divider.

The synthesizer circuitry 1306d may synthesize an output frequency for use by the mixer circuitry 1306a of the RF circuitry 1306 based on a frequency input and a divider control input. In some embodiments, the synthesizer circuitry 1306d may be a fractional NIN+ I synthesizer.

In some embodiments, frequency input may be an output of a voltage-controlled oscillator (VCO), although that is not a requirement. Divider control input may be an output of either the baseband circuitry 1304 or an application processor of the applications circuitry 1302 depending on the desired output frequency. Some embodiments may determine a divider control input (e.g., N) from a look-up table based on a channel indicated by the applications circuitry 1302.

The synthesizer circuitry 1306d of the RF circuitry 1306 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1306d may generate a carrier frequency (or component carrier) as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a local oscillator (LO) frequency (fLO). In some embodiments, the RF circuitry 1306 may include an IQ/polar converter.

The FEM circuitry 1308 may include a receive signal path which may include circuitry to operate on RF signals received from one or more antennas 1310, amplify the received signals and provide the amplified versions of the received signals to the RF circuitry 1306 for further processing. FEM circuitry 1308 may also include a transmit signal path which may include circuitry configured to amplify signals for transmission provided by the RF circuitry 1306 for transmission by one or more of the one or more antennas 1310. In various embodiments, the amplification through the transmit or receive signal paths may be done solely in the RF circuitry 1306, solely in the FEM circuitry 1308, or in both the RF circuitry 1306 and the FEM circuitry 1308.

In some embodiments, the FEM circuitry 1308 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1306). The transmit signal path of the FEM circuitry 1308 may include a power amplifier (PA) to amplify input RF signals (e.g., provided by RF circuitry 1306), and one or more filters to generate RF signals for subsequent transmission (e.g., by one or more of the one or more antennas 1310).

In the present embodiment, the radio refers to a combination of the RF circuitry 130 and the FEM circuitry 1308. The radio refers to the portion of the circuitry that generates and transmits or receives and processes the radio signals. The RF circuitry 1306 includes a transmitter to generate the time domain radio signals with the data from the baseband signals and apply the radio signals to subcarriers of the carrier frequency that form the bandwidth of the channel. The PA in the FEM circuitry 1308 amplifies the tones for transmission and amplifies tones received from the one or more antennas 1310 via the LNA to increase the signal-to-noise ratio (SNR) for interpretation. In wireless communications, the FEM circuitry 1308 may also search for a detectable pattern that appears to be a wireless communication. Thereafter, a receiver in the RF circuitry 1306 converts the time domain radio signals to baseband signals via one or more functional modules such as the functional modules shown in the base station 510 and the user equipment 560 illustrated in FIG. 2.

In some embodiments, the PMC 1312 may manage power provided to the baseband circuitry 1304. In particular, the PMC 1312 may control power-source selection, voltage scaling, battery charging, or DC-to-DC conversion. The PMC 1312 may often be included when the device 1300 is capable of being powered by a battery, for example, when the device is included in a UE. The PMC 1312 may increase the power conversion efficiency while providing desirable implementation size and heat dissipation characteristics.

While FIG. 13 shows the PMC 1312 coupled only with the baseband circuitry 1304. However, in other embodiments, the PMC 1312 may be additionally or alternatively coupled with, and perform similar power management operations for, other components such as, but not limited to, application circuitry 1302, RF circuitry 1306, or FEM circuitry 1308.

In some embodiments, the PMC 1312 may control, or otherwise be part of, various power saving mechanisms of the device 1300. For example, if the device 1300 is in an RRC_Connected state, where it is still connected to the RAN node as it expects to receive traffic shortly, then it may enter a state known as Discontinuous Reception Mode (DRX) after a period of inactivity. During this state, the device 1300 may power down for brief intervals of time and thus save power.

If there is no data traffic activity for an extended period of time, then the device 1300 may transition off to an RRC Idle state, where it disconnects from the network and does not perform operations such as channel quality feedback, handover, etc. The device 1300 goes into a very low power state and it performs paging where again it periodically wakes up to listen to the network and then powers down again. The device 1300 may not receive data in this state, in order to receive data, it must transition back to RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

The processors of the application circuitry 1302 and the processors of the baseband circuitry 1304 may be used to execute elements of one or more instances of a protocol stack. For example, processors of the baseband circuitry 1304, alone or in combination, may be used execute Layer 3, Layer 2, or Layer 1 functionality, while processors of the application circuitry 1302 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 14 illustrates example interfaces of baseband circuitry in accordance with some embodiments such as the baseband circuitry shown and/or discussed in conjunction with FIGS. 1-13. As discussed above, the baseband circuitry 1304 of FIG. 13 may comprise processors 1304A-1304E and a memory 1304G utilized by said processors. Each of the processors 1304A-1304E may include a memory interface, 1404A-1404E, respectively, to send/receive data to/from the memory 1304G.

The baseband circuitry 1304 may further include one or more interfaces to communicatively couple to other circuitries/devices, such as a memory interface 1412 (e.g., an interface to send/receive data to/from memory external to the baseband circuitry 1304), an application circuitry interface 1414 (e.g., an interface to send/receive data to/from the application circuitry 1302 of FIG. 13), an RF circuitry interface 1416 (e.g., an interface to send/receive data to/from RF circuitry 1306 of FIG. 13), a wireless hardware connectivity interface 1418 (e.g., an interface to send/receive data to/from Near Field Communication (NFC) components, Bluetooth® components (e.g., Bluetooth® Low Energy), Wi-Fi® components, and other communication components), and a power management interface 1420 (e.g., an interface to send/receive power or control signals to/from the PMC 1312.

FIG. 15 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540. For embodiments where node virtualization (e.g., NFV) is utilized, a hypervisor 1502 may be executed to provide an execution environment for one or more network slices/sub-slices to utilize the hardware resources 1500.

The processors 1510 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1512 and a processor 1514.

The memory/storage devices 1520 may include main memory, disk storage, or any suitable combination thereof. The memory/storage devices 1520 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1530 may include interconnection or network interface components or other suitable devices to communicate with one or more peripheral devices 1504 or one or more databases 1506 via a network 1508. For example, the communication resources 1530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

In embodiments, one or more elements of FIGS. 12, 13, 14, and/or 15 may be configured to perform one or more processes, techniques, or methods as described herein, or portions thereof. In embodiments, one or more elements of FIGS. 12, 13, 14, and/or 15 may be configured to perform one or more processes, techniques, or methods, or portions thereof, as described in the following examples.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Processing circuitry, logic circuitry, devices, and interfaces herein described may perform functions implemented in hardware and also implemented with code executed on one or more processors. Processing circuitry, or logic circuitry, refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits or circuitry to perform one or more sub-functions implemented to perform the overall function of “a processor”. Note that “a processor” may comprise one or more processors and each processor may comprise one or more processor cores that independently or interdependently process code and/or data. Each of the processor cores are also “processors” and are only distinguishable from processors for the purpose of describing a physical arrangement or architecture of a processor with multiple processor cores on one or more dies and/or within one or more chip packages. Processor cores may comprise general processing cores or may comprise processor cores configured to perform specific tasks, depending on the design of the processor. Processor cores may be processors with one or more processor cores. As discussed and claimed herein, when discussing functionality performed by a processor, processing circuitry, or the like; the processor, processing circuitry, or the like may comprise one or more processors, each processor having one or more processor cores, and any one or more of the processors and/or processor cores may reside on one or more dies, within one or more chip packages, and may perform part of or all the processing required to perform the functionality.

One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

Several embodiments have one or more potentially advantages effects. The enhancements advantageously enable a RAN intelligence controller (RIC) to receive or retrieve UE context related information from RAN nodes (including split architecture) over the E2 interface based on various triggering conditions, which is essential and a basic step for supporting various AI/ML use cases being discussed in O-RAN. For instance, determining user equipment (UE) context information associated with a UE, the UE context information comprising new information related to establishment of a new connection with the UE or related to an update of the UE context information for an existing connection with the UE may advantageously provide early notification of new or changed UE context information. identifying an event trigger associated with new information may advantageously provide early notification of new or changed UE context information. reporting the UE context information to a radio access network (RAN) intelligence controller (RIC) via the network interface may advantageously provide early notification of new or changed UE context information.

### EXAMPLES OF FURTHER EMBODIMENTS

The following examples pertain to further embodiments. Specifics in the examples may be used anywhere in one or more embodiments.

Example 1 is an apparatus to communicate user equipment context information, comprising a network interface for network communications; logic circuitry coupled with the interface to perform operations to determine user equipment (UE) context information associated with a UE, the UE context information comprising new information related to establishment of a new connection with the UE or related to an update of the UE context information for an existing connection with the UE; identify an event trigger associated with new information; and report the UE context information to a near real-time (RT) radio access network (RAN) intelligence controller (RIC) via the network interface. In Example 2, the apparatus of Example 1, wherein the logic circuitry comprises a processor and a memory coupled with the processor, the apparatus further comprising a radio frequency circuitry coupled with the logic circuitry, and one or more antennas coupled with the radio frequency circuitry. In Example 3, the apparatus of Example 1, wherein the new information comprises a change of value for a RAN parameter related to the UE context information. In Example 4, the apparatus of Example 1, wherein the new information comprises a new or updated sounding reference signal configuration or cell group configuration. In Example 5, the apparatus of Example 1, wherein the operations to report the UE context information comprises generation of a RAN parameter test condition information element to communicate a change of value for one or more RAN parameters. In Example 6, the apparatus of Example 1, wherein the event trigger comprises an Event Trigger Definition Format 4, wherein the Event Trigger Definition Format 4 comprises a UE identifier (ID) change ID equal to 1 to indicate a new UE connected or wherein the Event Trigger Definition Format 4 comprises a “UE context info” information element to indicate the UE context information changed. In Example 7, the apparatus of any one of Examples 1-6, wherein the operations further comprise operations to respond to a query from the RIC for UE context information associated with the UE, wherein the UE supports a non-grid of beams mode for beamforming. In Example 8, the apparatus of Example 7, wherein the query comprises a RIC query service, query style 1.

Example 9 is a method to communicate user equipment context information, comprising determining user equipment (UE) context information associated with a UE, the user equipment (UE) context information comprising new information related to establishment of a new connection with the UE or related to an update of the UE context information for an existing connection with the UE; identifying an event trigger associated with new information; and reporting the UE context information to a near real-time (RT) radio access network (RAN) intelligence controller (RIC) via the network interface. In Example 10, the method of Example 9, wherein the new information comprises a change of value for a RAN parameter related to the UE context information. In Example 11, the method of Example 9, wherein the new information comprises a new or updated sounding reference signal configuration or cell group configuration. In Example 12, the method of Example 9, wherein reporting the UE context information comprises generation of a RAN parameter test condition information element to communicate a change of value for one or more RAN parameters. In Example 13, the method of Example 12, wherein the event trigger comprises an Event Trigger Definition Format 4, wherein the Event Trigger Definition Format 4 comprises a UE identifier (ID) change ID equal to 1 to indicate a new UE connected or wherein the Event Trigger Definition Format 4 comprises a “UE context info” information element to indicate the UE context information changed. In Example 14, the method of any Example 9-11, further comprising responding to a query from the RIC for UE context information associated with the UE, wherein the UE supports a non-grid of beams mode for beamforming.

Example 15 is a machine-readable medium containing instructions at a first base station for mobile communication, which when executed by a processor, cause the processor to perform operations, the operations to determine user equipment (UE) context information associated with a UE, the user equipment (UE) context information comprising new information related to establishment of a new connection with the UE or related to an update of the UE context information for an existing connection with the UE; identify an event trigger associated with new information; and report the UE context information to a near real-time (RT) radio access network (RAN) intelligence controller (RIC) via the network interface. In Example 16, the machine-readable medium of Example 15, wherein the new information comprises a change of value for a RAN parameter related to the UE context information. In Example 17, the machine-readable medium of Example 15, wherein the new information comprises a new or updated sounding reference signal configuration or cell group configuration. In Example 18, the machine-readable medium of Example 17, wherein the operations to report the UE context information comprises generation of a RAN parameter test condition information element to communicate a change of value for one or more RAN parameters. In Example 19, the machine-readable medium of Example 18, wherein the event trigger comprises an Event Trigger Definition Format 4, wherein the Event Trigger Definition Format 4 comprises a UE identifier (ID) change ID equal to 1 to indicate a new UE connected or wherein the Event Trigger Definition Format 4 comprises a “UE context info” information element to indicate the UE context information changed. In Example 20, the machine-readable medium of any Example 15-17, the operations further to respond to a query from the RIC for UE context information associated with the UE, wherein the UE supports a non-grid of beams mode for beamforming.

Example 21 is an apparatus comprising a means for any Example 9-14.

1-20. (canceled)

21. An apparatus, comprising:
a network interface for network communications;
logic circuitry coupled with the interface to perform operations to:
determine user equipment (UE) context information associated with a UE, the UE context information comprising new information related to establishment of a new connection with the UE or related to an update of the UE context information for an existing connection with the UE;
identify an event trigger associated with new information; and
report the UE context information to a near real-time (RT) radio access network (RAN) intelligence controller (RIC) via the network interface.

22. The apparatus of claim 21, wherein the logic circuitry comprises a processor and a memory coupled with the processor, the apparatus further comprising a radio frequency circuitry coupled with the logic circuitry, and one or more antennas coupled with the radio frequency circuitry.

23. The apparatus of claim 21, wherein the new information comprises a change of value for a RAN parameter related to the UE context information.

24. The apparatus of claim 21, wherein the new information comprises a new or updated sounding reference signal configuration or cell group configuration.

25. The apparatus of claim 21, wherein the operations to report the UE context information comprises generation of a RAN parameter test condition information element to communicate a change of value for one or more RAN parameters.

26. The apparatus of claim 21, wherein the event trigger comprises an Event Trigger Definition Format 4, wherein the Event Trigger Definition Format 4 comprises a UE identifier (ID) change ID equal to 1 to indicate a new UE connected or wherein the Event Trigger Definition Format 4 comprises a “UE context info” information element to indicate the UE context information changed.

27. The apparatus of claim 21, wherein the operations further comprise operations to respond to a query from the RIC for UE context information associated with the UE, wherein the UE supports a non-grid of beams mode for beamforming.

28. The apparatus of claim 27, wherein the query comprises a RIC query service, query style 1.

29. A method, comprising:
determining user equipment (UE) context information associated with a UE, the UE context information comprising new information related to establishment of a new connection with the UE or related to an update of the UE context information for an existing connection with the UE;
identifying an event trigger associated with new information; and
reporting the UE context information to a near real-time (RT) radio access network (RAN) intelligence controller (RIC) via the network interface.

30. The method of claim 29, wherein the new information comprises a change of value for a RAN parameter related to the UE context information.

31. The method of claim 29, wherein the new information comprises a new or updated sounding reference signal configuration or cell group configuration.

32. The method of claim 29, wherein reporting the UE context information comprises generation of a RAN parameter test condition information element to communicate a change of value for one or more RAN parameters.

33. The method of claim 32, wherein the event trigger comprises an Event Trigger Definition Format 4, wherein the Event Trigger Definition Format 4 comprises a UE identifier (ID) change ID equal to 1 to indicate a new UE connected or wherein the Event Trigger Definition Format 4 comprises a “UE context info” information element to indicate the UE context information changed.

34. The method of claim 29, further comprising responding to a query from the RIC for UE context information associated with the UE, wherein the UE supports a non-grid of beams mode for beamforming.

35. A machine-readable medium containing instructions at a first base station for mobile communication, which when executed by a processor, cause the processor to perform operations, the operations to:
determine user equipment (UE) context information associated with a UE, the UE context information comprising new information related to establishment of a new connection with the UE or related to an update of the UE context information for an existing connection with the UE;
identify an event trigger associated with new information; and
report the UE context information to a near real-time (RT) radio access network (RAN) intelligence controller (RIC) via the network interface.

36. The machine-readable medium of claim 35, wherein the new information comprises a change of value for a RAN parameter related to the UE context information.

37. The machine-readable medium of claim 35, wherein the new information comprises a new or updated sounding reference signal configuration or cell group configuration.

38. The machine-readable medium of claim 37, wherein the operations to report the UE context information comprises generation of a RAN parameter test condition information element to communicate a change of value for one or more RAN parameters.

39. The machine-readable medium of claim 38, wherein the event trigger comprises an Event Trigger Definition Format 4, wherein the Event Trigger Definition Format 4 comprises a UE identifier (ID) change ID equal to 1 to indicate a new UE connected or wherein the Event Trigger Definition Format 4 comprises a “UE context info” information element to indicate the UE context information changed.

40. The machine-readable medium of claim 35, the operations further to respond to a query from the RIC for UE context information associated with the UE, wherein the UE supports a non-grid of beams mode for beamforming.
